(19) United States
(12) Patent Application Publication
(10) Pub. No.: US 2026/0274725 A1
(43) Pub. Date: Sep. 17, 2026

(54) SYSTEMS AND METHODS OF GAS REMEDIATION AND SEDIMENT HARVESTING

(71) Applicant: Floating Island International Inc., Shepherd, MT (US)

(72) Inventors: Bruce G. Kania, Shepherd, MT (US); Anne Kania, Shepherd, MT (US); Cornelius Valkenburg, Shepherd, MT (US); Kevin Holland, Shepherd, MT (US)

(21) Appl. No.: 19/674,179

(22) Filed: May 12, 2026

Related U.S. Application Data
(63) Continuation-in-part of application No. 19/090,814, filed on Mar. 26, 2025.
Application No. 19/090,814 is a division of application No. 18/640,022, filed on Apr. 19, 2024, now Pat. No. 12,275,660.
(60) Provisional application No. 63/461,378, filed on Apr. 24, 2023.

(51) Int. Cl. C02F 3/34; C02F 1/74; C02F 101/32; C02F 103/00

(52) U.S. Cl. CPC C02F 3/348; C02F 1/74; C02F 2101/32; C02F 2103/007; C02F 2201/005

(57) ABSTRACT

Gas remediation and sediment harvesting systems and methods are provided comprising an airlift assembly including an aeration system and one or more pipes or hoses configured for directional water flow. The one or more pipes or hoses include an upflow arm, a horizontal arm, and a downflow arm. The aeration system includes a coarse air blower. The coarse air blower introduces macrobubbles into the one or more pipes or hoses so the macrobubbles cause the airlift assembly to vibrate, which aids in concentrating and harvesting heavy metals and rare earth elements.

### CROSS-REFERENCE TO RELATED APPLICATIONS

This application is a continuation-in-part of and claims priority to U.S. patent application Ser. No. 19/090,814, filed Mar. 26, 2025, which is a divisional of and claims priority to U.S. patent application Ser. No. 18/640,022, filed Apr. 19, 2024, issued as U.S. Pat. No. 12,275,660 Apr. 15, 2025, which is a non-provisional of and claims priority to U.S. Patent Application Ser. No. 63/461,378, filed Apr. 24, 2023, each of which is hereby incorporated by reference in its entirety.

### FIELD OF THE DISCLOSURE

The following disclosure relates to systems and methods of gas remediation and sediment harvesting as well as systems and methods of reducing emissions of methane and volatile organic compounds.

### BACKGROUND

Biogenic methane emitting from nutrient-impaired water is the most direct manifestation of climate change occurring today. It is on pace to exceed all sources of anthropogenic carbon dioxide emission vectors in climate change impact. This form of methane has occurred during Earth's past and has led to the single most extreme extinction event in Earth's history. Biogenic methane emits from stormwater ponds, wetlands, rice paddies, and massive reservoirs, as well as every form of waterway in between. Today's inclination by humanity to add nutrients to water contributes to and exacerbates biogenic methane generation. This form of methane from freshwater alone is the single largest source of methane, and it outpaces emissions from oil and gas by some 50%.

Hotspots associated with this form of methane are now identifiable. Accordingly, the potential exists to capture and combust or biodigest at least a fraction of this extreme form of climate-changing greenhouse gas. Nitrous oxide, an even more extreme form of greenhouse gas, sometimes occurs in tandem with biogenic methane, and can also be reduced. Methane research has led to a means by which to pinpoint methane hotspots precisely. It is now known that under certain wintertime conditions, when a waterway is ice-covered, CH₄ hotspots manifest differently. Clouds of ebullition bubbles can be seen from above. In some instances, ice clarity is markedly different in such locations. The ice can be clear, compared to cloudy around the hotspot's perimeter. There can even be thinner ice, or actual open water from groundwater springs.

Freshwater covers approximately 6% of the surface of the earth, but the average depth is unknown. However, it is known that even relatively shallow water—in the range of about 6-10 feet deep, can stratify. Deeper water stratifies regularly, with the most dense water accumulating on the bottom of waterways. Water temperature dictates stratification and thus accumulates at the bottom. When stratified water mixes, which can occur on a seasonal basis and is frequently associated with weather events like cold rain, ice formation, and/or high winds, water oxygenation at benthic levels is natural and mixing of nutrients from the benthic layer into upper layers is possible. The most dense water normally includes high nutrient concentrations, led by nitrogen and phosphorus, and dissolved organic carbon and results in increased biological oxygen demand and correspondingly depleted oxygen because aerobic microbes consume available oxygen at high rates.

While methane is generated in sludge across the entire bottom of waterways, methanotrophs consume a high fraction of methane when given benthic aerobic conditions like those typically associated with the top layers of water. Note that biofilm-generating methanotrophs can adhere to and multiply on benthic surface area given aerobic conditions. In an ideal system, a waterway will consistently maintain aerobic status from top to bottom, resulting in the biologic consumption of methane by methanotrophs.

When a waterway is consistently aerobic, top to bottom, several primary results ensue: ubiquitous methanotrophs consume biogenic methane that would otherwise ebulate into the atmosphere. Concentrations of mosquito larvae that can flourish in anoxic water, or monoculture concentrations of anoxia resistant aquatic vegetation and/or harmful algae blooms are also prevented in that aerobic status allows for significant foraging of mosquito larvae by numerous aquatic life forms.

Instead, the waterway's water clarity improves, as does its biodiversity of aquatic and riparian aerobic life forms. In an aerobic setting, nutrients cycle into and through food webs at least 4.5 time faster than under anoxic of or mixed aerobic status. Ultimately this means that, besides the previously noted benefits of top to bottom aerobic status, the organic fraction of benthic sludge is oxidatively reduced, resulting in a waterway that maintains its depth, rather than becoming progressively shallower over a short term.

Methane is generated biologically under anaerobic conditions in sediments, anoxic waters, and underground springs. Springs that percolate into a waterway, especially in high-nutrient settings like those frequently associated with agriculture, can convey methane as source groundwater flow is generally anerobic. In winter, groundwater is typically warmer than the 0-4 degrees C. range of water under solid ice. This warmer, constant temperature, methane-laden water represents a marker for methane hotspots from groundwater springs as open water areas and ice occluded with bubbles when ice formation is occurring, or as atypical temperatures observed in a lake's stratified water layers during other seasons.

Today's satellite imagery capabilities are significantly improved compared to the recent past. While today monitoring of methane emissions over water from space is complicated by refraction above waterbodies, monitoring of methane hotspots adjacent to water per the differentiation points noted here is possible. As such, this ability could represent a means by which to identify and place optimal methane mitigation systems over various waterbodies. We also know that highly eutrophic waterbodies as measured by chlorphyll density from algae are sources of methane hotspots from waterbodies. With today's carbon/methane credit voluntary market, this means by which to track methane hotspots could be an effective client identification advantage.

Biogenic methane gas dissolves in water at increased concentrations with increasing water depth, and methane can be held in stasis when generated under extreme pressure, as in water that is more than 50 meters deep. Methane release occurs with some frequency in association with deep hydroelectric reservoirs that discharge benthic water outflows. Significant concentrated methane emissions occur when water is depressurized by passing through turbines or spillways. When dissolved methane passes through the extreme aeration associated with hydroelectric turbines and spillways, methane degasses from the water and enters the atmosphere, where its concentrated deleterious climate-changing impact takes place.

Above dam and below dam methane release can be managed. There is potential to capture a fraction of this methane and expose it to biodigestion by methanotrophs. Strategically designed and positioned floating treatment wetlands can achieve this. A range of additional benefits is associated with this process, including: nutrients that otherwise spawn harmful algae blooms are additionally biodigested and cycled into methanotroph/periphyton/aquatic food webs, resulting in a high level of waterway productivity; water quality and clarity is improved, allowing sunlight to contribute to a waterway's food web productivity. All of the above contribute to an aquatic system's biodiversity.

Similarly, beneficial aerobic life forms like freshwater sponge can be inoculated into floating treatment wetland matrix and provide ongoing water filtration of sediment. Freshwater sponge also represents an addition or alternative to macrophytic nutrient sequestration. Freshwater sponge is a basic heterotrophic life form that occurs on submerged surface area, including the bottom of floating treatment wetlands, where it is resistant to excessive grazing by waterfowl. In an exemplary embodiment, sponge grows into island matrix, providing further grazing protection.

There are two primary engines of life: biological and solar. Heterotrophs rely primarily on one, autotrophs primarily on the other. By maximizing nature's wetland effect, both engines of life can be maximized. Floating treatment wetlands and targeted aeration provide optimal aquatic conditions and habitat for microbes, plants, and upper level biota from both engines of life.

Biogenic methane emissions associated with fresh water include a number of flux pathways. Sustenance of highly effective strains of methanotrophs across all emission zones is highly desirable. As with any biofilm-generating microbe, surface area combined with optimization of aeration, circulation, nutrients, residence time, pH, and temperature can maximize growth of desired methanotroph culture. Such optimization is not sufficient, however, to provide broad dispersal across every eco-zone of a waterway or reservoir. Inoculation of a highly mobile form of forage, like minnows, with methanotrophs, could leverage a waterway's food web, and result in broad and cost-effective dispersal.

The archaea genus of microbes, which includes both methanogens and methanotrophs, is an ancient strain that has existed on Earth for millions of years in a wide range of extreme environments. Methanogens, for example, thrive even in the gut of bovines as well as on surface area associated with thermal hot springs, or tundra, and extremely pressurized deep aquatic zones. Similarly, methanotrophs are also ubiquitous but operate optimally given aerobic status.

Methanotrophs can survive the relatively simple gastric system of minnows, just as methanogens survive in more complex and rigorous gastric settings. Floating treatment wetlands can form optimum hatcheries for both methanotrophs and minnows. And releasing methanotroph inoculated forage into waterways represents an elegant dispersal of selected methanotrophic strains.

Accordingly, there is a need for biogenic methane mitigation systems and methods capable of effectively dispersing methane-consuming methanotrophs. There is a need for systems and methods that can deploy methanotrophs to mitigate methane in stormwater ponds, reservoirs, lakes and wetlands. There is also a need for biogenic methane mitigation systems and methods that can quickly and effectively introduce, disperse and sustain methanotrophs across entire waterways. There is a need for new systems and methods of remediation and sediment biodigestion harvesting as well as reducing emissions of methane and volatile organic compounds.

### SUMMARY

The present disclosure, in its many embodiments, alleviates to a great extent the disadvantages of known biogenic methane mitigation systems by providing innovative and effective systems and methods of remediation and sediment biodigestion harvesting as well as systems and methods of reducing emissions of methane and volatile organic compounds. Disclosed biogenic methane mitigation systems and methods, referred to as Remediation of Aquatic Methane (RAM), incorporate one or more floating island, floatovoltaic (floating island plus photovoltaics), and/or solar/thermal technology, to support and run state-of-the-art air/oxygenation and propulsion systems with which to strategically oxygenate anaerobic/anoxic bottom zones within nutrient-impaired freshwater systems.

Biogenic methane can ebullate and/or dissolve into nutrient-impaired water from benthic sludge over a broad area of a freshwater waterway. Maintaining dissolved oxygen over the hyperlimnion of nutrient-impaired waterways can result in a standing population of methanotrophs in the top layer of sludge. The methanotrophs grow optimally given nitrogen, phosphorus, carbon and of course, methane, and a 0.1 ppm or greater concentration of dissolved oxygen. Such a population will biodigest at least a fraction of biogenic methane that otherwise ebullates directly into earth's atmosphere.

Exemplary embodiments of a biogenic methane mitigation system comprise a floating island and an airlift system including an aeration system. The floating island has two ends and is comprised of a biofilm-reactive matrix. The floating island may have a water-impermeable top surface and a carbon substrate incorporated into the biofilm reactive matrix. The airlift system may be on one or both ends of the floating island and include one or more pipes or hoses. The biogenic methane mitigation system strips methane from the waterway treated zone and reduces ebullition as a combination of macro- and micro-treatment system bubbles are passed under and into the floating island, thereby dissolving gaseous methane for active methanotroph culture biomass growth and causing mitigation of the methane generated by sediment anaerobic decomposition. In exemplary embodiments, the airlift system is an open channel system. The system also dissolves H2S for biological remediation back to sulfate for odor and toxic gas emission management.

The floating island may be deployed above benthic sludge and the active methanotroph culture sustained on the surface of the benthic sludge by maintaining oxygenated benthic conditions. In exemplary embodiments, an optimum level of at least 0.1 ppm of dissolved oxygen is maintained at the top of the benthic sludge. The airlift system may have one more valves, which, when opened, allow the biofilm reactive matrix to be inoculated with the active methanotroph culture. The biogenic methane mitigation system may further comprise a deflector plate connected to the airlift system. In exemplary embodiments, the system includes at least one blower. The aeration system may comprise a micro-bubbler for enhanced oxygenation and methane removal efficiencies.

The aeration system also reduces sediment ebullition by, among other things, creating density gradient flows towards the aeration system. As discussed in more detail herein, by pumping and removing dissolved methane gas from the benthic zone, methane buildup to saturation levels is prevented. Essentially, the removal of benthic methane makes room for the water to dissolve methane much faster and instead of forming ebullition bubbles that release methane emission directly at the air/water interface. Thus, the aeration system can extract methane for aerobic zone treatment especially when waters are anoxic during periods of high BOD.

An exemplary biogenic methane mitigation system comprises a floating island, an airlift system including an aeration system, a deflector plate, a blower, and a bubbler. The floating island has two ends and is comprised of a biofilm-reactive matrix. The airlift system may be on one or both ends of the floating island and may comprise one or more pipes or hoses. The bubbler is configured to pass bubbles under and into the floating island. The airlift exhaust, which may contain high levels of methane, also can be configured to pass bubbles under and into the floating island for bioremediation. The bubbles may comprise macro- and micro-treatment system bubbles that expose methane to active methanotroph culture, which may perform in variable dissolved oxygen conditions. Exemplary embodiments further comprise a diffuser diffusing the bubbles. A tether may be provided to accommodate changes in water level.

A system for capturing and harvesting methane comprises a floating island comprised of a biofilm-reactive matrix and an airlift system on the floating island. The airlift system comprises one or more pipes and an aeration system including a blower blowing air and a bubbler configured to pass bubbles into water flowing in the one or more pipes, thereby facilitating capture and harvesting of methane. In exemplary embodiments, the airlift system is a closed or semi-closed system. Blower intake may be recycled by collecting bubbles being released from the floating island system. The capturing and harvest system may further comprise a catalytic converter or a combustion chamber fluidly connected to one of the one or more pipes. The capturing and harvest system may further comprise a vented foam buildup plate connected to one of the one or more pipes. When water is maintained as aerobic top to bottom, airlift methane emissions are minimal. Blower intake can also be directed to collect methane air emissions from other sources (such as a dairy barn).

Exemplary methods of mitigating biogenic methane comprise deploying a floating island on a surface of water and passing macro- and micro-treatment system bubbles under and into the floating island. The floating island includes a biofilm-reactive matrix with an active methanotroph culture and an airlift system on one or both ends of the floating island. Passing the bubbles under and into the floating island exposes methane to active methanotroph culture and causes biodigestion of the methane on what is essentially a one for one basis, whereby methane consumed by methanotrophs is cycled into CO2, a much less climate impactful biogas. In a floating island biofilm reactor, a portion of the CO2 then transitions into the autotrophic arm of a water body's food web.

Oxygenation capacity of disclosed airlift systems and synergistic floating treatment wetlands ideally adjacent to such systems, provide an efficient and cost effective ability to mitigate and bioremediate a vast range of toxic chemical pollutants. Similarly, system offgas, for example, when collected at the juncture of the horizontal and downward arm of the system, can contain combustible concentrations of, for example, methane, which could effectively be used to fuel the system's energy and combustion source needs.

Methane concentrations needed for combustion can be further manipulated by oxygen concentration. Typically, around 4,000 ppm, or 4% of methane in air is needed, but greater or lesser proportions may be effective. Employment of an air oxygen concentration feature used with the small volume of air going through the microbubble diffusers enhances oxygenation levels further, and today there are several such commercial off the shelf systems. Such a system operating on a primary treatment wastewater system adds to the purpose of such systems, in that nutrient reduction and cycling of the entire wastewater ponds is improved. And of course, methane that would otherwise emit into earth's atmosphere is captured and transitioned into clean energy or as fishery biomass carbon storage. An air concentration device may be used to enhance water oxygenation efficiency.

The disclosed systems and methods employ any combination of nano-, micro-, and standard bubbles to generate both thrust and oxygenation. The system operates within a designable window, ultimately defined by treatment water's residence time in the system's treatment pipe and may employ various forms of air and concentrated oxygen bubbler systems to maximize for oxygenation of water in its most dense form, without changing treatment water density.

By passing macro- and micro-treatment system bubbles under and/or into a floating island, disclosed embodiments expose methane to active methanotroph culture. This advantageously results in mitigation of methane, conversion to bacterial biomass, bioremediation of organic pollutants and, with foam collection, mitigation of PFAS compounds. Exemplary systems mitigate against the anaerobic benthic waters “first flush” phenomenon, where relatively high volumes of methane and hydrogen sulfide are emitted.

Microbubbles in the downflow arm of the disclosed airlift system represent a unique opportunity to exceed the standard optimal dissolved oxygen transfer rate of 30% for standard lake aeration systems. This is because the high and adjustable flow rate can defeat microbubble buoyancy and maintain them in the pipe for an extended period, exposing the gas bubbles to a much larger volume of water. By manipulating the flow rate, the size and type of gas bubbles, and/or the length of the outflow pipe, either vertically or horizontally, the system achieves a much higher oxygen transfer rate. Using O2-enhanced gas mixtures in the downpipe, microbubbles are converted to nanobubbles which are neutrally buoyant and have known enhanced sediment bioactivity effects. Thus, a fine tuned system can synergize a blend of coarse bubbles generated by airlift with fine bubble diffusers to increase the oxygen transfer rate. Fine bubble diffusers, because they use a small volume of air, can be used economically.

Other factors that can be influenced, like temperature of inflow air, further enhance the ability to achieve benthic oxygenation without destratification. When RAM's objective is to oxygenate the benthic zone, intake and outflow points must be kept at or near the sludge/sediment layer, typically in the deepest waters of a stratified waterbody. In addition, that manipulation of flow rate, bubble size and oxygen concentration in the outflow pipe directed downward can be manipulated to achieve a combustible concentration of methane, and combustion for other VOCs, at the juncture of the horizontal and vertical downflow arm.

Gas remediation and sediment harvesting systems and methods of reducing emissions of methane and volatile organic compounds also are provided. There are two primary factors associated with sediment harvesting embodiments. The first is that, even without any of the powerful added “pull” associated with the air lift system, the suction associated with a deep intake point and with minimal “lift” the flow rate using the airlift is substantial. Exemplary embodiments can lift smaller rocks, and certainly finer grain substrate. Key for maximum water/sediment flow rate is to avoid attempting to lift outlet water/sediment significantly above the surface.

The second factor is the extreme pulsing vibration associated with the coarse bubble airlift technology, which can be synergized into a “rocker table” effect. That is, the whole system vibrates, but this is especially evidenced at the horizontal arm of the system. To harness this phenomenon, a graduated screen/filter may be included within the horizontal arm of the system, and thus the system can collect dense particulates and gravels which can contain minerals such as gold and/or rare earth elements. The system can easily discard the “light” less dense fraction of sediment particulates, such as those found in clays.

An exemplary gas remediation and sediment harvesting system comprises at least one airlift assembly including an aeration system and one or more pipes or hoses configured for directional water flow. The one or more pipes or hoses include an upflow arm directed into sediments for collection, a horizontal arm, and a directed discharge arm. The aeration system includes a coarse air blower and one or more microbubble air diffusers in fluid communication with the one or more pipes or hoses. If outflow is directed into the benthic layer, it is possible to avoid surface water increases in turbidity for waters deeper than 15 feet and useful/suitable for creating a deeper spot in the pumping area and which then increases the zone of influence for the system by enhancing density pressure gradient flows within outlying areas.

The one or more microbubble air diffusers introduce microbubbles into the one or more pipes or hoses, thereby adding oxygen to water flowing through the one or more pipes or hoses. The coarse air blower introduces macrobubbles into the one or more pipes or hoses such that the macrobubbles create pressure to move the water flowing through the one or more pipes or hoses so the microbubbles can enhance oxygenation of the water flowing through the one or more pipes or hoses. More particularly, the macrobubbles create atmospheric pressure differentials that push the water up the pipe, providing energy to move the water and create turbulence. A second airlift or second airlift assembly or pump could be provided to pressurize outflow air in the horizontal arm.

In exemplary embodiments, the microbubbles provide enhanced oxygenation of the water. The one or more microbubble air diffusers may include one or more longitudinal diffusers located in the downflow arm. The macrobubbles generate water flow by displacing water and create turbulence in the horizontal arm, concentrating rare earth elements and heavy metals. Addition of air/oxygen to the one or more pipes or hoses enables extraction/stripping remediation of volatile organic compounds.

In exemplary embodiments, a first angled channel is formed where the upflow arm meets the horizontal arm, and a second angled channel is formed where the horizontal arm meets the downflow arm. The first and second angled channels may be formed by one or more directional plates or by angled pipe or hose pieces. In exemplary embodiments, the horizontal arm includes an airtight lid and one or more air vents. The downflow arm may have a bottom section and a middle section and define a plurality of holes that are relatively smaller at or near the bottom section and are relatively larger at or near the middle section. The horizontal arm may include a sluice riffle box or have a filter mesh as its bottom surface to separate particles by density.

In exemplary embodiments, the gas remediation and sediment harvesting system further comprises one or more ballast tanks connected to the one or more pipes or hoses. In exemplary embodiments, the airlift assembly is incorporated into a floating island on a surface of water. The gas remediation and sediment harvesting system may further comprise one or more solar panels providing electricity to power the system and one or more collection bags to collect heavy sediment. The system may define at least one sediment collection orifice in one or more of the one or more pipes or hoses. The at least one airlift assembly may comprise a second airlift assembly or a pump to pressurize outflow air in the horizontal arm.

Exemplary methods of gas extraction/stripping remediation and sediment harvesting comprise the steps of deploying an airlift assembly incorporated into a floating island in a body of water. The airlift assembly includes an aeration system and one or more pipes or hoses including an upflow arm, a horizontal arm, and a downflow/water outlet discharge arm such that water flows through the one or more pipes or hoses. The methods include introducing macrobubbles into the upflow arm or the horizontal arm. The macrobubbles create pressure to move the water flowing through the one or more pipes or hoses, causing vibration within the one more pipes or hoses, thereby providing a rocker table effect.

Exemplary methods further comprise introducing microbubbles into the downflow arm to increase oxygenation in the downflow arm or raising the level of microbubbles introduced during emission of volatile organic compounds to reduce or terminate emissions. The microbubbles add oxygen to the water flowing through one or more pipes or hoses. Methods may include closing an airtight lid on the horizontal arm to capture off gas. Exemplary methods further comprise discarding light sediment and concentrating denser sediment concentrates containing gold and other rare earth elements. Removing organic sludge containing sediment layers also reduces methane, COD and BOD levels of benthic waters. By placing a floating island above the sediment disturbance area, noxious and methane ebullitions released by dredging can be captured and bioprocessed.

Exemplary methods further comprise containing outflow air from the horizontal arm and directing the outflow air under and through adjacent floating treatment wetlands. Outflow air and associated biogas may be directed under and through the biofilm reactive surface area of floating treatment wetlands. In exemplary methods, an airtight lid on the horizontal arm is closed to capture off gas, and the off gas can be passed through the airlift assembly a second time. In exemplary methods, the aeration system achieves up to 100 percent transfer of oxygen bubbles to the water flowing through the one or more pipes or hoses. A directional plate may be connected to the pipes or hoses and its angle adjusted to regulate turbulence and water flow volume.

In exemplary embodiments, the intake pipe can be moved across the sediment-containing area to remove sediments. The intake pipe can be directed just below the surface of water for removal of duckweed and floating algae clumps. Sediment/sludge harvesting/removal can create a deeper spot in the pumped area especially for waterbodies with a flat bottom. Other site selections possible are to take benthic waters in a selected bay of a lake to provide no-toxic aerobic sanctuary areas for immigrating fish coming from other lake areas that are anoxic or have toxic H2S buildup and to locate benthic aeration pumping where anoxic groundwater inflows occur.

Accordingly, it is seen that systems and methods of biogenic methane mitigation are provided. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a side view of an exemplary embodiment of a system of biogenic methane mitigation showing an exemplary airlift system in accordance with the present disclosure;

FIG. 2 is a side view of an exemplary embodiment of a system of biogenic methane mitigation showing an exemplary airlift system in accordance with the present disclosure;

FIG. 3 is a top view of an exemplary embodiment of a system of biogenic methane mitigation showing an exemplary airlift system in accordance with the present disclosure;

FIG. 4 is a top view of an exemplary embodiment of a system of biogenic methane mitigation showing a floating island array in accordance with the present disclosure;

FIG. 5 is a side view of an exemplary embodiment of a module interconnection walkway for a system of biogenic methane mitigation in accordance with the present disclosure;

FIG. 6 is a top view of an exemplary embodiment of a system of biogenic methane mitigation in accordance with the present disclosure

FIG. 7 is a side view of an exemplary embodiment of an airlift system in accordance with the present disclosure;

FIG. 8A is a side view of an exemplary embodiment of a methane capture and harvesting system showing an exemplary airlift system in accordance with the present disclosure;

FIG. 8B is a side view of an exemplary embodiment of a methane capture and harvesting system showing an exemplary airlift system in accordance with the present disclosure;

FIG. 9 is a side view of an exemplary embodiment of a system of biogenic methane mitigation used in connection with a hydroelectric turbine in accordance with the present disclosure;

FIG. 10 is a top view of an exemplary embodiment of a system of biogenic methane mitigation used in connection with a hydroelectric turbine in accordance with the present disclosure;

FIG. 11 is a side view of an exemplary embodiment of a system of biogenic methane mitigation using grid power in accordance with the present disclosure;

FIG. 12 is a side view of an exemplary embodiment of a system of biogenic methane mitigation using off-grid power in accordance with the present disclosure;

FIG. 13 is a side view of an exemplary embodiment of a gas remediation and sediment harvesting system in accordance with the present disclosure;

FIG. 14 is a side view of an exemplary embodiment of a gas remediation and sediment harvesting system in accordance with the present disclosure;

FIG. 15 is a side view of an exemplary embodiment of a gas remediation and sediment harvesting system incorporated with a floating island in accordance with the present disclosure;

FIG. 16 is a top perspective view of an exemplary embodiment of a gas remediation and sediment harvesting system incorporated with a floating island in accordance with the present disclosure;

FIG. 17A is a side view of an exemplary embodiment of a gas remediation and sediment harvesting system and method before variable depth oxygenation treatment in accordance with the present disclosure;

FIG. 17B is a side view of the gas remediation and sediment harvesting system and method of FIG. 17A after variable depth oxygenation treatment in accordance with the present disclosure;

FIG. 17C is a side view of the gas remediation and sediment harvesting system and method of FIG. 17A after variable depth oxygenation treatment in accordance with the present disclosure;

FIG. 18 is a side view of an exemplary embodiment of a gas remediation and sediment harvesting system in accordance with the present disclosure;

FIG. 19A is a side view of an exemplary embodiment of a horizontal arm and sediment collection bag in accordance with the present disclosure;

FIG. 19B is a side view of an exemplary embodiment of a gas remediation and sediment harvesting system with a sediment collection bag in accordance with the present disclosure;

FIG. 20 is a side view of an exemplary embodiment of a gas remediation and sediment harvesting system with a gravity flow exit channel in accordance with the present disclosure;

FIG. 21 is a top view of an exemplary embodiment of a gas remediation and sediment harvesting system with an island tether configuration in accordance with the present disclosure; and

FIG. 22 is a side view of an exemplary embodiment of a gas remediation and sediment harvesting system incorporated with a floating island in accordance with the present disclosure.

### DETAILED DESCRIPTION

In the following detailed description of exemplary embodiments of the disclosure, reference is made to the accompanying drawings, which are not drawn to scale and the illustrated components are not necessarily drawn proportionately to one another, in which like references indicate similar elements, and in which is shown by way of illustration specific embodiments in which disclosed systems and devices may be practiced. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

Disclosed embodiments can be used in conjunction with floating islands as described in one or more of U.S. Pat. Nos. 8,250,808, 8,327,579, 8,132,364, 8,372,277, 9,181,105, 7,784,218, 7,941,970, 7,810,279, and U.S. patent application Ser. No. 15/655,941, each of which is hereby incorporated by reference herein.

Embodiments of the present disclosure target biogenic methane reduction and sediment harvesting in aquatic settings. More particularly, the target is primarily oxygenation of the bottom layer of water where anaerobic status allows for methane generated within the sludge to ebullate (bubble up) and avoid digestion by aerobic methanotrophs. The system achieves this by strategically oxygenating the bottom of a waterway. It has the potential to limit oxygenation to stratified benthic water. Thus, exemplary systems and methods achieve major aquatic methane reductions because the greatest methane emissions are almost always limited to the anaerobic bottom zone of a waterway and with methane concentrations highest in the water body's deepest zone.

In exemplary embodiments, archipelagos of floating treatment wetland (FTW) modules, or floating islands, ideally seamless, are positioned over methane-emitting hotspots primarily associated with nutrient-impaired waterways. Biogenic methane is generated in anaerobic layers of benthic sludge. If there is no aerobic cap or lid present on the uppermost layer of sludge, such methane percolates through sediment and dissolves in benthic waters or forms bubbles and rises through the water column with minimal biodigestion by biofilm-generating methanotrophs that are limited by surface area and dissolved oxygen status. Such methane hotspots represent concentrated windows of opportunity for biomitigation within the biofilm reactive surface area provided by FTWs. Archipelagos of FTWs can provide an effective lid between such methane and Earth's atmosphere.

Such FTW archipelagos may include gas barriers to prevent peripheral escape of methane between modules. The peripheral gas barriers may also serve as access walkways allowing for appropriate O&M activities on the FTWs. Such activities include plant and module stewardship. This can include harvesting top growth of plants, and maintenance of the internal and external tether system holding the archipelago in place, and occasional replacement of the carbon nodules that convey methane into the biofilm-reactive surface area immediately under the gas impermeable walkway.

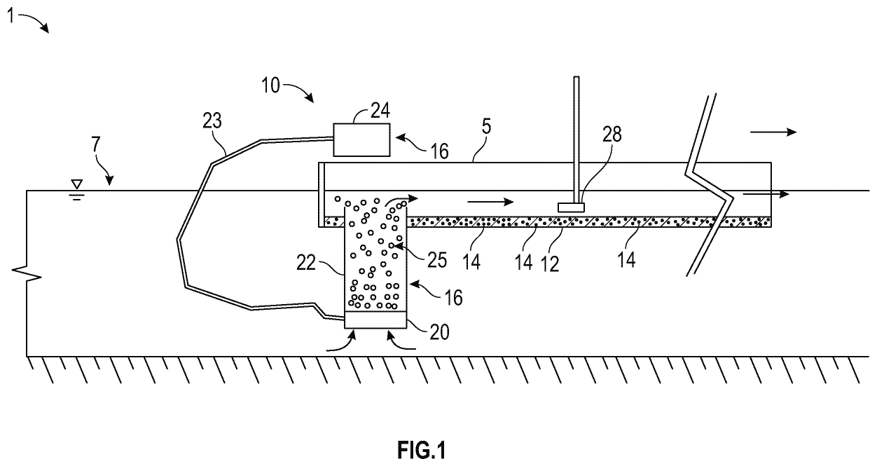

With reference to FIGS. 1-4, exemplary embodiments of a biogenic methane mitigation system 1 will now be described. The system 1 comprises one or more floating islands 5, each island having two ends 6 with an airlift, or directional plate, system 10 incorporated onto the floating island at one or both ends. As discussed in more detail herein, the airlift system 10, 110, 210, 310 may be designed in various ways and typically includes one or more pipes 22 and/or hoses 23. Additional major components of the system 1 include an aeration system 16, a deflector plate 18, and a bubbler or diffuser 20. The floating island 5 is comprised of a biofilm-reactive matrix 12 that is inoculated with active methanotroph culture 14.

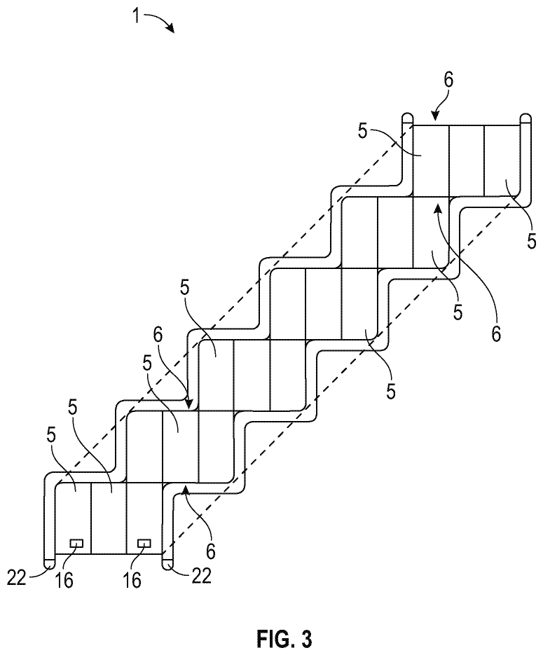

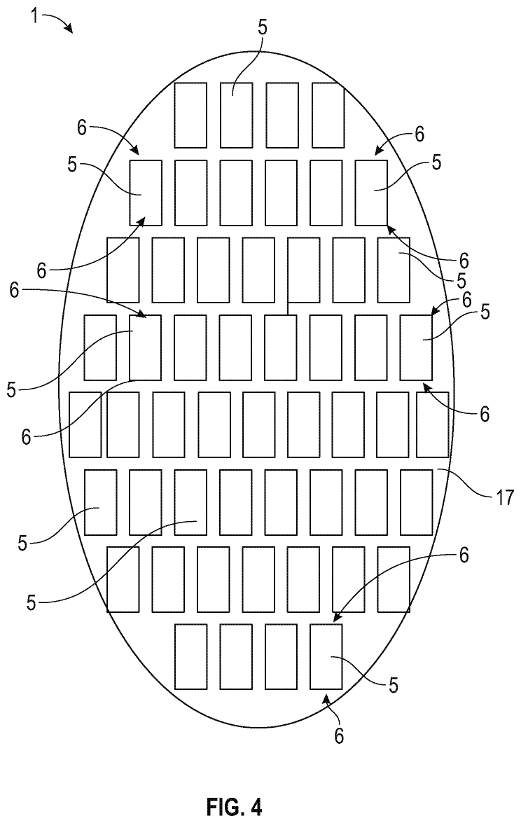

As best seen in FIGS. 3 and 4, the biogenic methane mitigation system could be comprised of multiple islands 5 or island modules connected by impermeable walkways 17. Archipelagos of floating islands 5 are designably buoyant. Accordingly, they can designably support human traffic, or other features including macrophytes, solar panels, oxygenation technology, buildings and more. However, the space between modules 5 represents a gap through which ebullating greenhouse gas may escape into the atmosphere.

The seams, where the walkway 17 connects with FTW modules 5 along module perimeters, are as gas-impermeable as possible. Therefore, exemplary embodiments provide a gas-impermeable barrier between modules, forcing greenhouse gases, including methane, nitrous oxide, and carbon dioxide, to pass through saturated FTW matrix 12 before potentially accessing Earth's atmosphere. As such gas moves through FTWs 5, it is exposed to methanotrophs 14 and other microbes capable of biodigesting the gas.

Gas-impermeable sheeting 11 can be designably rigid to support a wide range of infrastructure, as well as human ingress and egress. Designing for gas-impermeable perimeter sealing of the sheeting 11 insures maximum biodigestion potential of the entire archipelago. By incorporating pressure-fitting perimeter connections along every edge of the sheeting 11 into this design, greenhouse gases are forced to move laterally instead of upwards, and in the process be exposed to FTW's biofilm reactive capacity. Since ebullating greenhouse gas is essentially low pressure once it gasifies, a simple pressure fit along the sheeting's perimeter is sufficient to guide most gas into FTW-saturated matrix 12. The gas impermeable walkway 17 could be made in whole or in part of buoyant concrete.

There are numerous ways to achieve the pressure fit required to fulfill this design. For example, sheeting 11 can be bolted down into matrix 12. It can also be forced into tight spacial fittings. The rigid sheeting 11 can include a soft foam-like material, to facilitate this pressure-fit feature. Such examples anticipate some small loss of gas, which is acceptable relative to present status, where a full range of greenhouse gas currently enters Earth's atmosphere unimpeded.

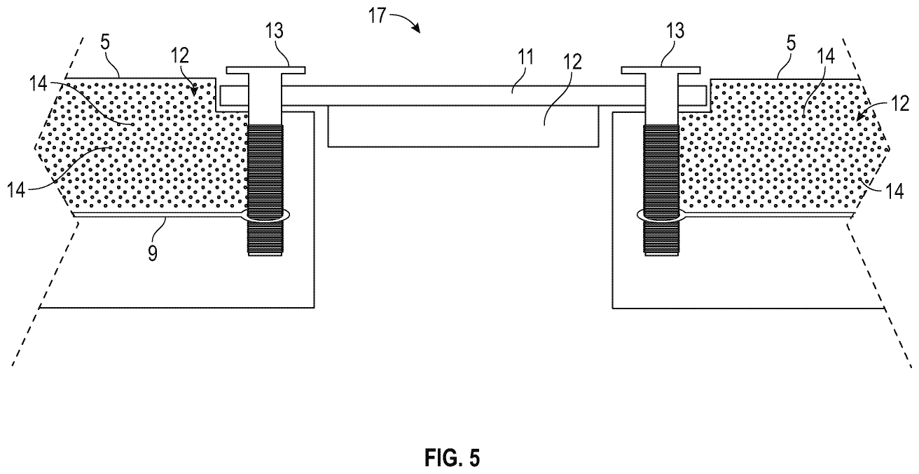

An exemplary structure for an interconnecting walkway 17 is shown in FIG. 5. It can be seen how square planted island modules 5 are connected by plates of gas-impermeable sheeting 11. An impermeable sheet 11 is laid across the matrix layer 12 and may be fixed to each floating island module 5 by connector pins 13 and a webbing attachment strap 9. The sheeting 11 connects each module 5, and rests on top of each module's perimeter, allowing for an air space along each module's entire perimeter.

The walkways 17 themselves can incorporate biofilm reactive surface area on their undersides, bonded in place, and vertical absorption nodules designed to lift/convect methane into the biofilm reactive surface area can be incorporated therein. The nodules can include an optimal, and ideally replaceable, carbon and nutrient component. Incorporation of a nodule replacement capability from the walkway 17 will expedite the process of sustaining methanotroph biodigestion of methane.

Other benefits of disclosed embodiments include that modules are seamless, which minimizes connection labor and breakdown. Also, the sizing of modules maximizes for freight efficiency. The module/walkway interface is readily assembled in the variable and sometimes rigorous natural settings associated with natural waterways. The sheeting can be sufficiently rigid to allow for human passage; thus, it can be walked on. This in turn allows for efficient O&M of islands, as well as density of macrophyte planting. Methane that has just passed through the extreme turbine phenomenon will gasify relatively quickly downstream of dams. Accordingly, it is critical that floating treatment wetlands in such settings be high-energy capable. Disclosed systems can function even with turbulence and changing water levels.

Biogenic methane hotspots associated with smaller waterways can be identified and targeted. Passive floating treatment wetlands that incorporate this gas barrier feature can be positioned immediately over such settings. Gas condensation will enhance for biomitigation of this methane, as the gas condenses on the bottom of the sheeting and drips back into water and island matrix. This design minimizes the volume of FTW needed to mitigate concentrated biogenic methane hotspots. Baseline measurement is fundamental to maximize for both efficacy and cost effectiveness.

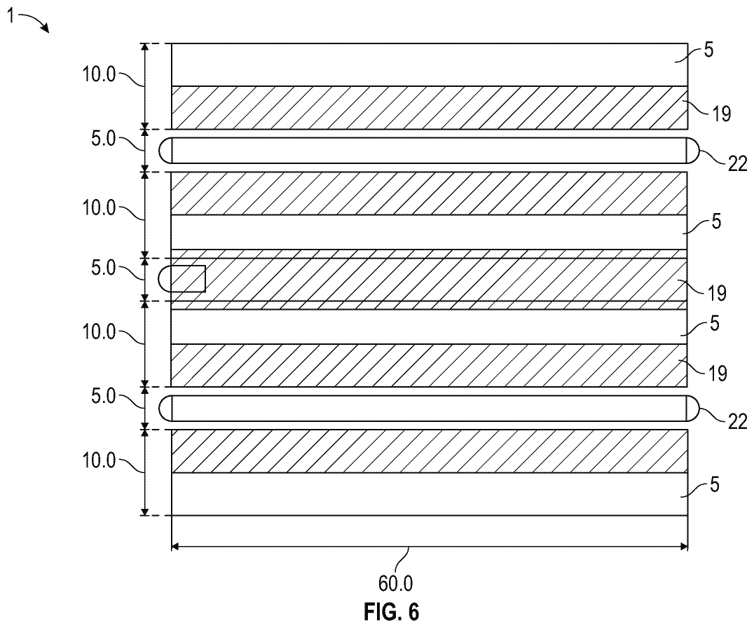

As illustrated in FIG. 6, spawning channels 19 for protection of fish, birds, and other animals can be provided, and aeration pipes 22 might be located in the channels between modules 5. Exemplary embodiments have channels 19 for methanotroph/minnow propagation. The system 1 can allocate a small portion of oxygenated water into channels 19 built into the system for enhancement of both populations. Minnows will graze associated periphyton that occurs on channel perimeter matrix. The minnows can be released into the main waterway as a broad dispersal mechanism. Exemplary embodiments biomimic conditions conducive to both methanotrophs and a form of forage-like minnows. Higher-order biota will ultimately consume some of the minnows, and they will also disperse and in turn, inoculate other biota. Most waterways already include natural methanotrophic bacteria.

Advantageously, disclosed systems and methods optimize synergistic circulation. By opening a valve and pulling from the airlift flow volume, which is liftable by at least as much as 14 inches above static waterbody level, island biofilm reactive matrix 12 can be inoculated with benthic-adapted archaea genus aerobic microbes capable of biodigesting methane. Inflow stratified benthic water, rich with nutrients can be valved off of the main piped inflow water volume and gravity flowed into island matrix 12 and over treatment pipe 22 of the airlift system 10, 110, 210, 310. Cooler benthic waters can be utilized as a nutrient source to support fish hatchery embodiments and, with mixing of surface waters, be used to create ideal fish hatchery temperature conditions, with the methanotrophic bacterial biomass being the food source.

This process results in ongoing exposure of methanotrophs 14 to the various forms of nitrogen, phosphorus, and nitrous oxide. Carbon substrate can be incorporated into island matrix 12 as well as macrophyte planting pockets spaced around the island. Additional carbon may be present as total suspended solids (TSS) in the inflow water, as well as in and around the plants and the humus they generate. Thus, the methanotrophs 14 have carbon, nitrogen and phosphorus, and dissolved oxygen, livable temperature range, and residence time, all within the island matrix 12.

The airlift system 10, 110, 210, 310 is built onto the floating island 5 at any part of the island. It could be one on or both ends 6 of the floating island 5, or be built so it is on neither end, and may cover or extend from different parts of the island. By incorporating the airlift system 10, 110 on the floating island 5, the biogenic methane mitigation system 1 can readily reverse flow of treatment water. This would likely expand the system's zone of oxygenation influence. The “charging station” design using solar panels or other off-grid energy production could enhance this potential.

The airlift system 10, 110, 210, 310 has a network of one or more pipes 22 or hoses 23 for injecting and moving air and treatment water through the airlift system and the greater system 1. Exemplary embodiments include PVC pipe filled with about three feet (though the amount and size could vary) of sludge with high organic content, with about a 3-foot (though the amount and volume could vary) layer of nutrient impaired water above the saturated sludge, mounted vertically. Pipe can be any suitable diameter, and in exemplary embodiments is 12 inches in diameter, and ten feet in length, providing four feet of headspace. Pipe may be lidded, to prevent methane loss. Control is identical sludge/water profile, left undisturbed. The test unit may be aerated and the methane concentration in the headspace of pipes monitored.

The “open channel” airlift systems of use in the biogenic methane mitigation system 1 advantageously move a high volume of water. Disclosed designs for the “in-pipe” systems allow the system to return oxygenated water to the strata it was pulled from. Doing so quickly, to avoid temperature change, contributes greatly to the system's goal of oxygenating benthic water without destratification. Maintaining a level of a minimum of 0.1 ppm of dissolved oxygen at the top of benthic sludge is the target, but other levels could work as well, including as low as 0.02 ppm. This minimal concentration of dissolved oxygen sustains a biogenic methane consuming population of archaea genus methanotrophs and reduces ebullition-based methane generated in benthic sludge by as much as 80%. Introduction air and whatever biogas it includes is vented off at the end of the treatment surface to avoid interference with return treatment water to desired depth. As discussed in more detail herein, biogas in the headspace of the enclosed, in-pipe, including methane, nitrous oxide, and hydrogen sulfide may be combusted or sparged into biofilm reactive floating island matrix for optimal reduction or mitigation. Under winter ice-over conditions this design creates a large ice-free area for natural oxygenation of surface waters and habitat and water for wildlife.

Exemplary systems offer a readily accessible treatment platform, as water from any depth is accessible at or near the surface within the flume or pipe. Note that the flume or pipe can be of any configuration, including round, rectangular, square or even inverted cone shape (approaching an umbrella shape). Exemplary systems bring a high volume of water from selected depth to the surface, contained within the flume, including dissolved inorganic and organic compounds, off-gasses as well as particulates, as in solids and colloidals, organic foams, which can be collected, combusted or directed into and through biofilm digestive systems like floating island matrix, or adsorbent or absorbent materials within the flume like biochar or iron, or simply allowed to remain in the treatment water where they will be exposed to additional passes through the system.

This feature means that pervasive and difficult to treat agents including petroleum products, halogenated solvents, PCBs, PFAS, and a wide range of additional VOCs, can be mitigated. Again, mitigation includes combustion, bio reduction, chemical reaction, foam collection, and/or collection on absorbents or within adsorbents. Vigorous aeration by macrobubbles also produces foam, which can be collected/skimmed from the flowing stream to remove it. Dissolved organics are converted into foams from the water, and the foams contain high levels of nutrients and chemicals such as PFAS.

This feature also provides for additional means to add dissolved oxygen or provide for reduction of available phosphorus. For example, pure or concentrated oxygen can be added to an, ideally, airtight system. Iron, in a wide range of forms, can be added to the flume to cause excess phosphorus to settle into benthic sediment while also providing a critical mineral supplement, especially for optimal methanotroph growth, with which to enhance any food web. Hydrogen peroxide is another potential treatment agent, although its biocidal capacity could also incapacitate beneficial methane reducing microbes. Various waterways experience a range of REDOX potential, which dictates whether they generate either of two competing agents: biogenic methane or hydrogen sulfide. Neither of these competing agents is beneficial. Both represent environmental hazards, and both can be collected, combusted, or directed into and through biofilm digestive systems like floating island matrix.

Returning to FIG. 1, an exemplary airlift system 10 is built onto floating island 5, which sits on the surface of a body of water 7. The airlift system 10 includes a hose 23, suitable for moving compressed air, fluidly connected to an air blower 24 on one end and a diffuser 20 on the other end. An aeration system 16 may be provided and can include a small micro bubbler positioned at the interface between sludge and water. Embodiments of the airlift system 10, 110, 210, 310 advantageously reduce aquatic methane by sustaining a methane consuming population at this benthic sludge/water interface. Suspended solids associated with polluted water are typically concentrated at this interface, and provide concentrated surface area. By maintaining 0.02 ppm or more of dissolved oxygen an active population of methanotrophs can be sustained and in the process consume 50 to 80% of methane that is generated under anaerobic conditions in sludge.

Temperature and residence times vary but should be above the freezing point of water. Together, the air blower, hose, and diffuser may be referred to as an aeration system 16. The diffuser 20, which may be a bullseye diffuser, is located under an end 6 of the floating island 5 to generate air bubbles 25 from the water. In exemplary embodiments, the diffuser 20 is set up to be about one foot above the bottom of the body of water 7. The hose 23 extends from the air blower 24 located on or above the island 5 at or near an end 6 of the island to the diffuser 20 under water underneath the same end 6 of the island 5. Thus, the air blower 24 sends compressed air through the hose 23 to the diffuser 20 so it can generate air bubbles 25.

The bubbles 25 are passed under and into the floating island 5, thereby exposing methane in the water to the active methanotroph culture 14 and causing mitigation of the methane. More particularly, water flows through the diffuser 20 and macro- and/or micro-treatment system bubbles 25 rise up through riser pipe 22 into the streambed directly above the matrix channel floor of the floating island 5. The active methanotroph culture 14 in the biofilm-reactive matrix 12 digests methane that is in the water as it flows through. A velocity meter 28 may be provided to measure and display the velocity of the flowing water.

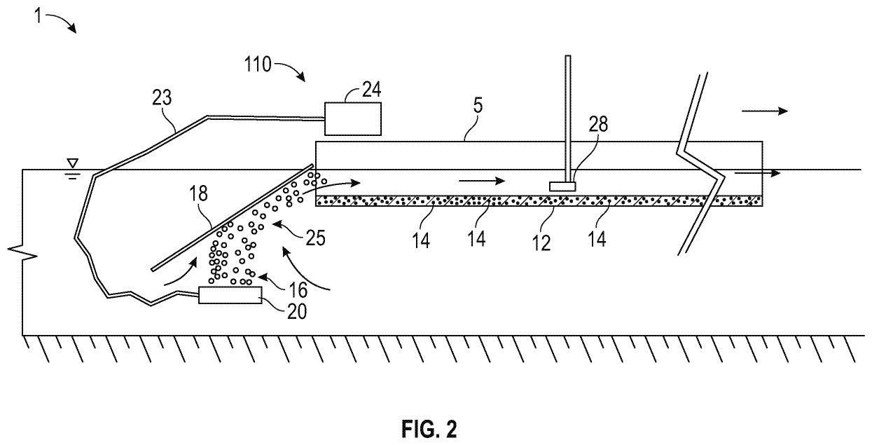

Turning again to FIG. 2, an airlift system 110 with an angled deflector plate 18 will now be described. The airlift system 110 is built onto floating island 5, which sits on the surface of a body of water 7. The hose 23, air blower 24, and diffuser 20 are configured similarly to those in the airlift system 10 shown in FIG. 1 and perform the same functions. In system 110, however, deflector plate 18 is connected to the airlift system 110 and set up at an angle relative to the floating island 5. Thus, instead of the water flowing from the diffuser 20 up through a riser pipe, the bubbles 25 generated by diffuser 20 float upwards and are guided by the angled deflector plate 18 into the streambed directly above the matrix channel floor of the floating island 5 for methane digestion by the active methanotroph culture 14 in the biofilm-reactive matrix 12.

This airlift system 110 with the angled deflector is more efficient at producing horizontal stream flow than airlift system 10 shown in FIG. 1. The unit output rate of this system 110 is 4.8 gpm/watt. Variations in the configuration and number of certain components are possible, e.g., the deflector plate could located at the riser outlet, and a single blower or two blowers could be used. A velocity meter 28 also may be provided.

It should be noted that transferring the high volume of oxygen generated by disclosed airlift blower technology into oxygen-starved benthic water may be limited by the surface area of induced bubbles 25. While nanobubbles may be the ultimate size scale, the pressure and generational challenges associated with their formation are limiting. Microbubbles represent a relatively efficient means by which to oxygenate benthic water. Combining the generation of microbubbles with high levels of induced turbulence over the shortest time period is our goal. Disclosed systems and methods target the highest level of oxygen transfer into benthic water flow over the shortest time, to prevent temperature change which would otherwise result in destratification. A person of ordinary skill in the art would understand that oxygen concentration technology could influence design prerogatives. It also should be noted that macrobubbles are vastly more efficient at inducing high water volume flow than either micro-or nanobubbles.

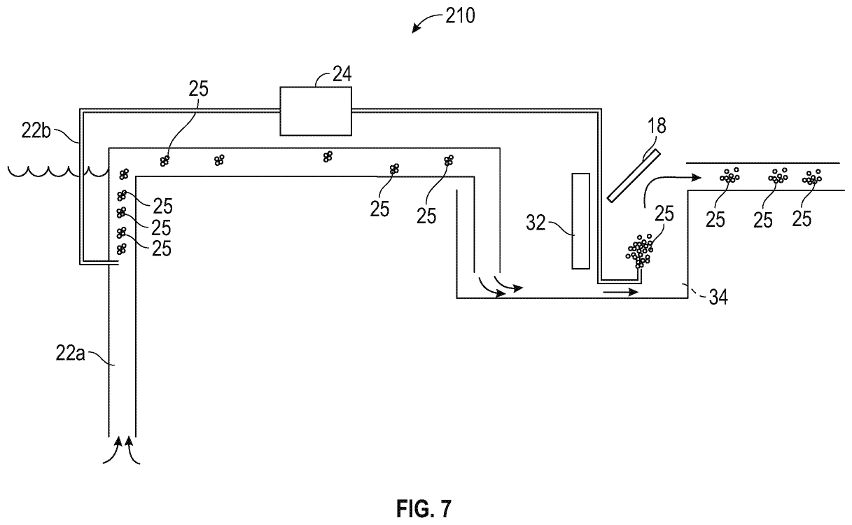

Turning to FIG. 7, airlift systems 210 could incorporate additional components and designs to optimize performance. An airlift system 210 with double air injection is illustrated in FIG. 7. Blower 24 is fluidly connected to water inlet pipe 22a by primary air injection pipe 22b, and a secondary air injection pipe also is provided. Water and bubbles 25 flow through the system 210, passing divider wall 32 and going through a tank 34. From there, they are guided by angled deflector plate 18 into the aerated water outlet pipe 22d. Some of these embodiments result in aeration of water in the outlet pipe 22d and off-gassing of gases including methane, hydrogen sulfide, and/or nitrous oxide into the headspace above the water flow in the horizontal portion of the pipe 22e. This sets the stage for concentration of valuable and combustible methane, the prospect of flaring off the methane and nitrous oxide, or the re-direction of these gases into and through floating islands 5 to be biodigested.

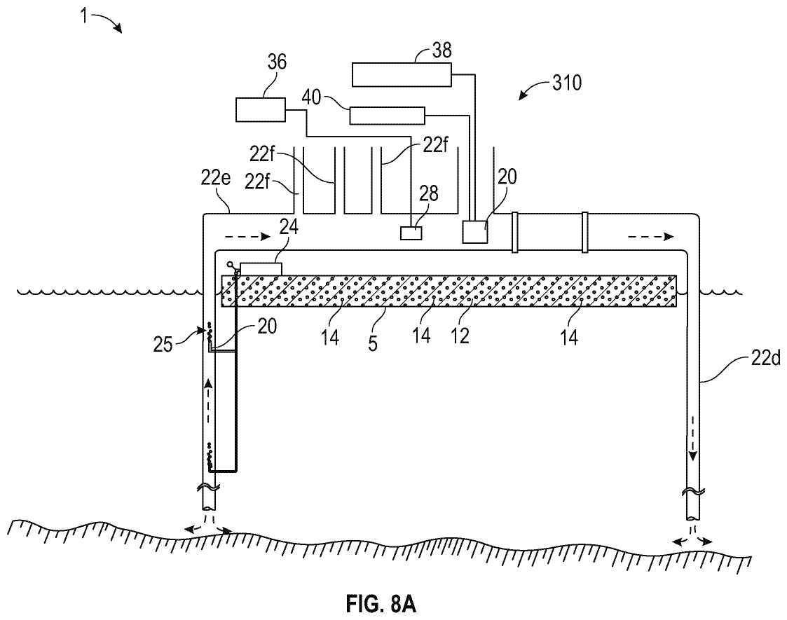

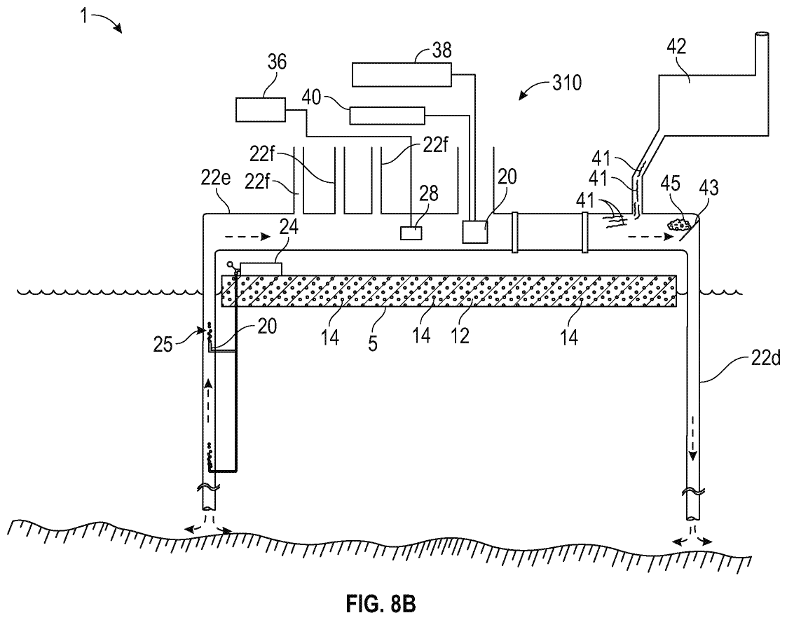

As shown in FIGS. 8A and 8B, exemplary embodiments utilize enclosed pipe 22e in the airlift system 310. As discussed in detail herein, the closed, in-pipe system advantageously facilitates the capture and harvesting of methane, hydrogen sulfide, and nitrous oxide to be concentrated for commercial combustion or to be flared off or passed under the islands 5 for biodigestion. The enclosed pipe 22e may vary in size, and in exemplary embodiments, is 6- to 12-inch pipe. Enclosed pipe 22e has an inlet in a first section located in the body of water 7 where water flows in and a section that extends above the floating island 5 and a third section under water with an outlet where the water flows back into the body of water after treatment. A compressor or blower 24 provides air to diffuser or bubbler 20, which is fluidly connected to the first section of enclosed pipe 22e and injects air bubbles 25 into the water flowing up the pipe. The bubbles 25 travel through the enclosed pipe 22e above the floating island 5, thereby facilitating capture or harvesting of the methane and other gases.

A biogas reduction point occurs in the horizontal flume or pipe section of the in-pipe airlift system 310. Methane and hydrogen sulfide and nitrous oxide gas or liquid present within process water exposed to extreme turbulence induced by macro, micro and/or nano bubbles of air or oxygen in the horizontal section of the flume/pipe 22e is oxidized and present in the flume/pipe headspace. This combination of air and biogas can be vented off of the flume/pipe 22e through vent pipes 22f for commercial combustion. Alternatively, if the concentrations do not justify commercialization, the biogas can be flared off.

FIG. 8B illustrates one way to flare off the off-gas 41 and make sure the methane or nitrous oxide is combusted. As shown, the off-gas 41 may be vented into a catalytic converter or combustion chamber 42 fluidly connected to pipe 22e. If heavy metals are involved, foam 45 may collect in pipe 22e. The foam 45 that accumulates in the horizontal portion of the airlift system 310 is primarily dissolved organics and likely to include concentrated per- and polyfluoroalkyl substances (PFAS) because the system pulls from the deep zone where bioaccumulated PFAS ends up concentrating in sediments. The foam 45 containing PFAS can be readily harvested/skimmed off by incorporating a skimmer technology, e.g., a vented foam buildup plate 43 with a timed skimmer or suction device.

A molecule of methane can be transitioned on a one-for-one basis into a molecule of carbon dioxide or as nitrogen gas on a two for one basis. Since methane is many times more impactful than carbon dioxide, this process represents an effective greenhouse gas mitigation strategy. While hydrogen sulfide is not a greenhouse gas, it is both toxic and noxious. It can also be reduced by combustion. Alternatively, all three of these biogases can be sparged into and through a floating treatment wetland and cycled into microbes and their residue, ultimately forming the biofilm base of periphyton, a forage material to sustain and trigger a dynamic aquatic food web.

A velocity meter 28 and flowrate recorder 36 may be provided to measure and display the velocity and flow rate, respectively, of the flowing water. One or more vent pipes 22f off the main section of enclosed pipe 22e allow venting as the water flows through. In some embodiments, a compressed air supply 38 is in fluid connection with a second bubbler 20 or nanobubbler located in the main section of enclosed pipe 22e. Certain parameters are monitored, such as variation in methane concentrations over time and the presence of natural methanotrophs in both settings. These parameters can indicate efficacy of oxygenation of the benthic zone. Essentially, a lid of methanotrophs can mitigate biogenic methane emissions from nutrient-impaired water when oxygen status is maintained. Sampling ports are designed to measure water flow rate, perform servicing of microbubble aeration systems, and to collect water samples.

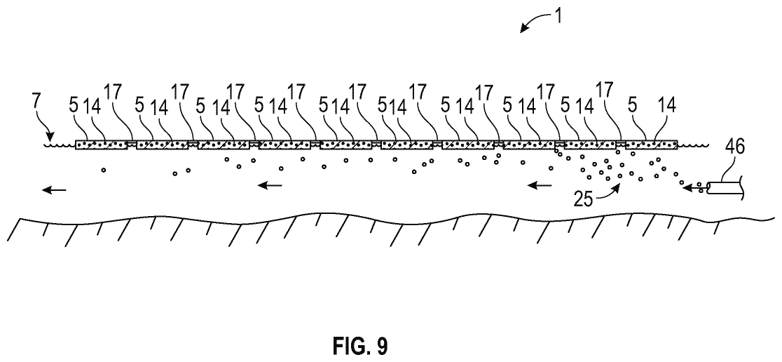

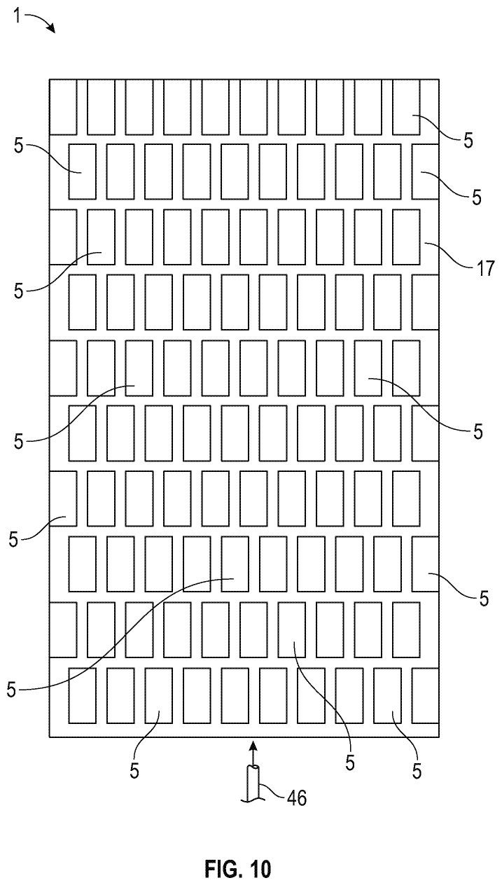

Referring now to FIGS. 9 and 10, an important application for disclosed embodiments is hydroelectric turbines. It is apparent that very high volumes of methane are released through bottom outflow turbines associated with deep reservoirs. Biogenic methane gas is dissolved and held in statis at higher concentrations when generated under extreme pressure, as in water more than 50 meters deep. This condition occurs with some frequency in association with deep hydroelectric reservoirs. When the dissolved methane passes through the extreme depressuration and aeration associated with hydroelectric turbines, a significant fraction of it gasifies and enters the atmosphere, where its concentrated deleterious climate-changing impact takes place in a very small area of the entire reservoir.

An estimate is that as much as 80% of methane generated in a reservoir is released immediately below dam turbines. By measuring dissolved methane concentration in front of turbines, the amount of methane released downstream can be estimated from flow rate data and verified with atmospheric laser sensor systems, or by Eddy CoVariance monitoring.

Using exemplary embodiments, oxygenation of deep water above hydroelectric dams maintains aerobic status of water that passes through turbines and removes benthic methane for bioremediation treatment. Passive floating treatment wetlands positioned immediately downstream from turbines can maximize for strategic surface area and leverage the oxygenation associated with the water's exposure to turbines. Disclosed treatment processes reduce dissolved methane concentration when oxygenating a stratified layer selectively, whereas general deep-water oxygenation also results in reduced methane.

Passing methane through a biogenic methane mitigation system 10, 110, 210, 310 including floating islands 5 positioned immediately below turbines digests some fraction of methane that otherwise releases directly into the atmosphere. Use of state-of-the-art methane monitoring technology can establish accurate baseline emission data. Positioning biofilm reactive surface area 12, in the form of floating islands 5, over water immediately after the water passes through the concentrated oxygenation effect provided by turbines and exits with gas bubbles 25 from a turbine outlet pipe 46, results in biological oxidation of the methane and reduces the volume that enters the atmosphere. Such a design can do this with no added mechanical input, but instead will strategically apply nature's wetland effect to address what is otherwise a massive point source of biogenic methane emissions, i.e., biogenic methane releases from below deep reservoirs 7.

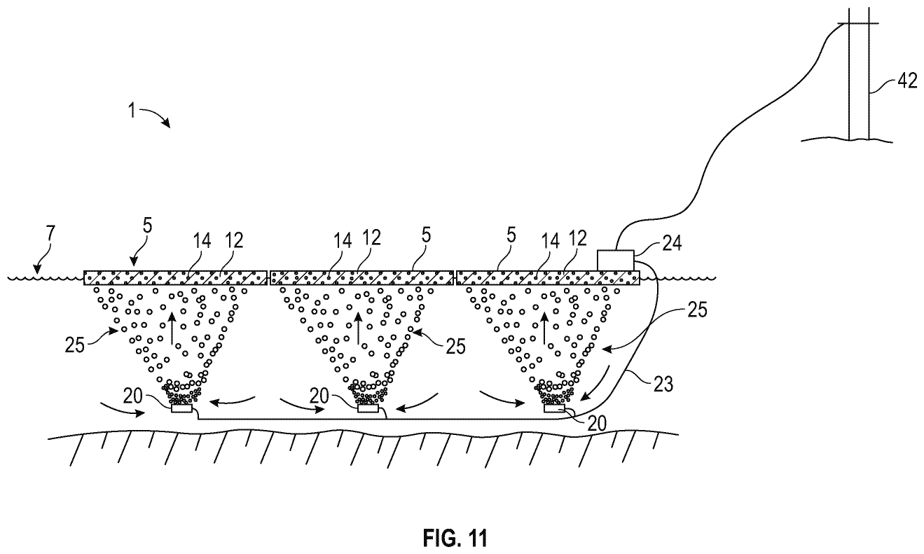

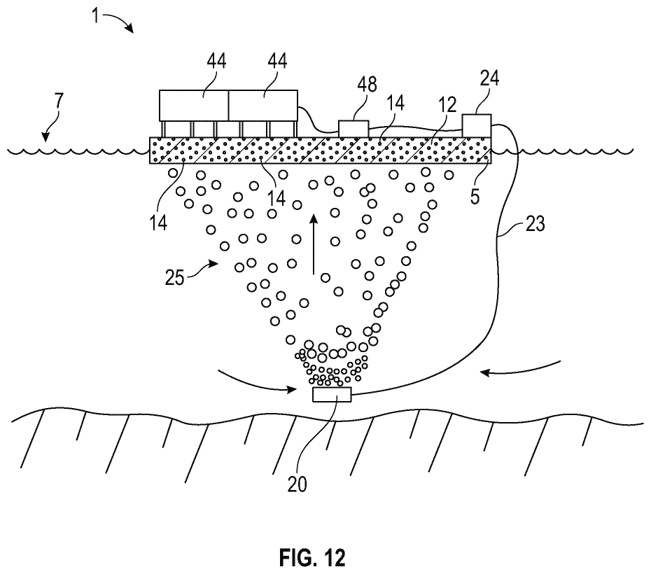

Exemplary embodiments employ various solutions to provide the power needed to run the system 1. As shown in FIGS. 8A and 8B, a DC power supply 40 may be provided. FIG. 11 illustrates a biogenic methane mitigation system 1 taking electricity from a grid-based power station 42. Many of the locations at which biogenic methane is generated are off-grid, so exemplary embodiments use solar panels 44 and/or solar/thermal power generation systems with one or more batteries 48 incorporated for energy storage, as depicted in FIG. 12. Combined floating islands and solar arrays are described in U.S. patent application Ser. No. 15/655,941, filed Jul. 21, 2017, which is hereby incorporated by reference in its entirety.

Advantageously, disclosed embodiments include unique features to sustain in high energy settings. These features include, but are not limited to, a water impermeable top surface to prevent continuous total saturation, which is likely to inhibit macrophyte growth, at least for optimal plant species; a matrix structure on the underside of islands to uplift and direct water flow into primary island matrix; a tether designed to accommodate rapidly changing water levels; internal reinforcement webbing to prevent FTW breakdown; a strain of methanotrophs that perform in high dissolved oxygen conditions, rather than 0.1-0.2 ppm.

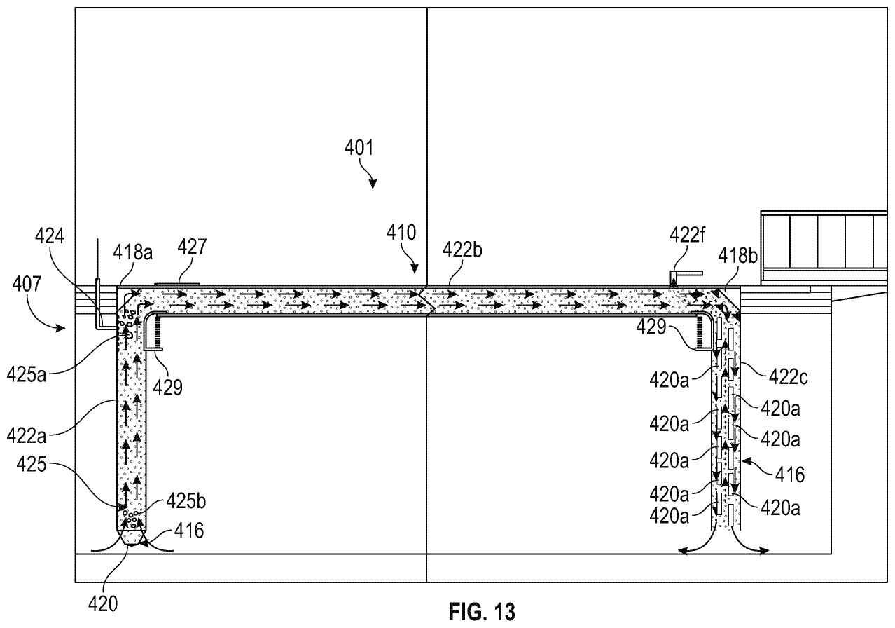

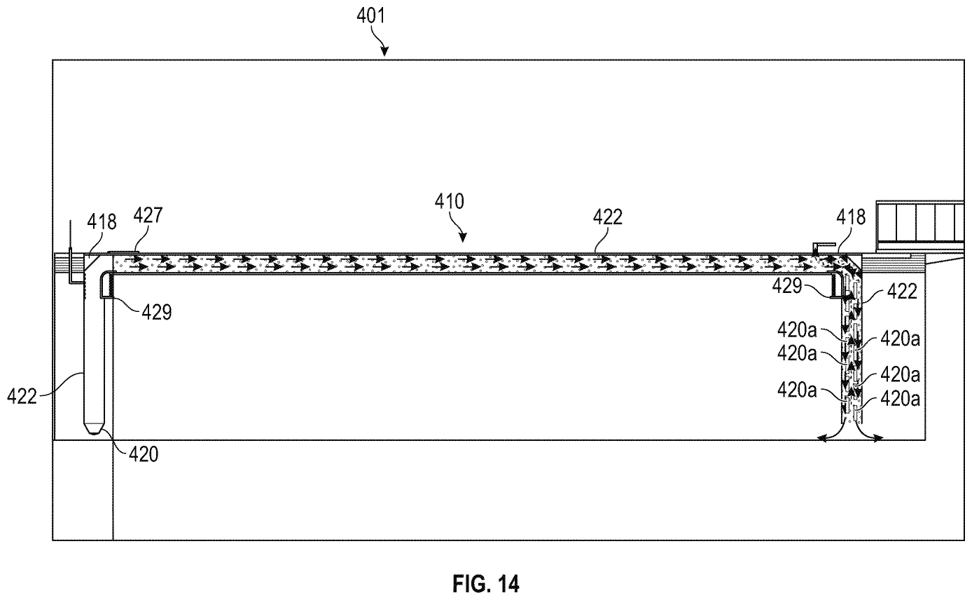

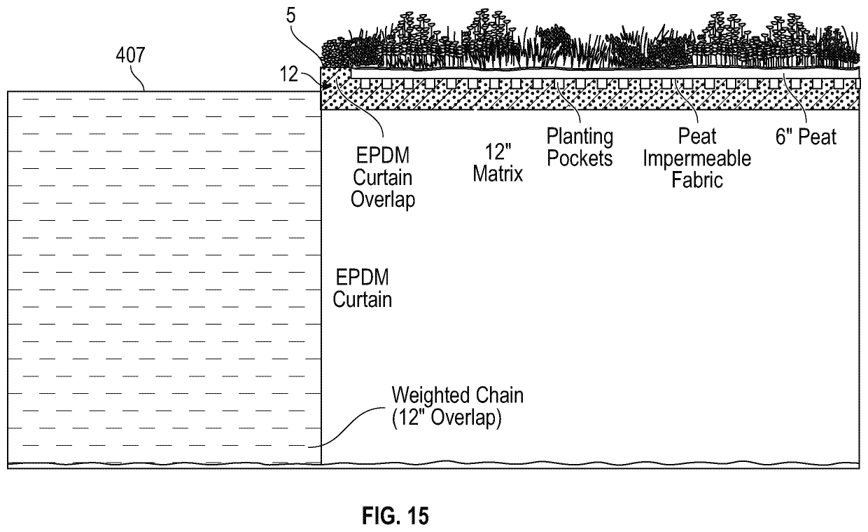

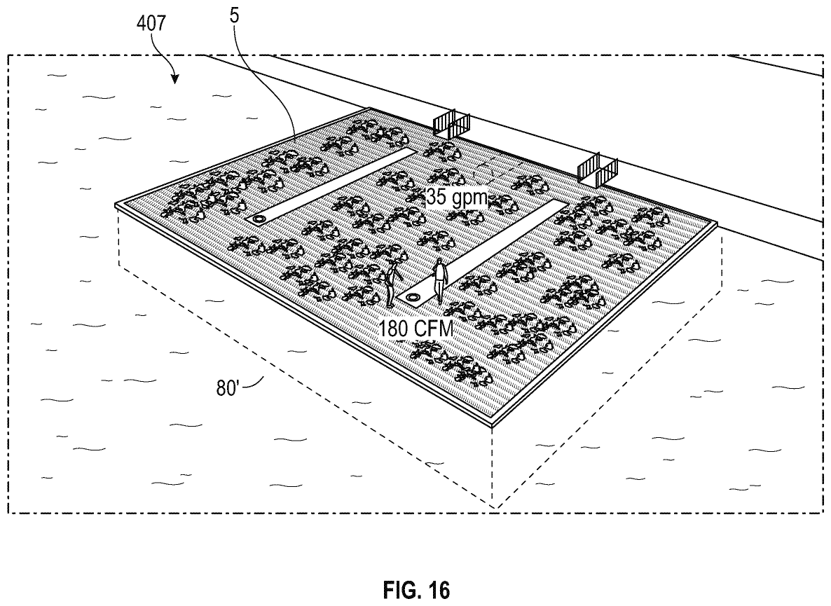

With reference to FIGS. 13-16 and 17A-17C, exemplary embodiments of gas remediation and sediment harvesting systems and methods will now be described. Gas remediation system 401 is comprised of an airlift assembly 410, which includes a network of pipes or hoses 422 and several components that serve as an aeration system 416. As shown in FIGS. 15 and 16, the gas remediation system may be incorporated with a floating island 5, comprised of a biofilm-reactive matrix 12 that is inoculated with active methanotroph culture 14.

As illustrated in FIG. 13, an exemplary configuration of pipes or hoses 422 has an upflow arm 422a, a horizontal arm 422b at the top of the network, and a downflow arm 422c. This configuration allows water to flow into the bottom of the upflow arm 422a and up to a corner, where it flows through the horizontal arm 422b at the top of the airlift assembly 410, turns again down and flows through the downflow arm, exiting the assembly 401 back into the body of water 407. The three arms 422a, 422b, 422c of the pipe or hose network are fluidly connected and may be separate components held together mechanically or one piece integrally formed.

The aeration system 416 introduces oxygen into the gas remediation system 401 and provides large and small bubbles 425 via one more more coarse air blowers 424 and air diffusers 420. In exemplary embodiments, a coarse air blower 424 is in fluid communication with the network of pipes or hoses 422 and introduces macrobubbles 425a into the system 401. As best seen in FIG. 13, coarse air blower 424 is fluidly connected to the upflow arm 422a at or near the top of the arm and extends above the water line to pull in the air. Fine bubble or microbubble diffusers 420 can be located at various points in the network of pipes or hoses 422.

In exemplary embodiments, a microbubble diffuser 420 is located at or near the bottom of the upflow arm 422a to introduce microbubbles 425b into the water as it enters the system. In addition, one ore more fine bubble longitudinal diffusers 420a are provided and located in the downflow arm 422c to introduce microbubbles 425b to outflow water. Adding a stream of fine bubbles 425b into the system 401 results in a surprising increase in oxygen transfer into the volume of water passing through the system, with bubbles in the downflow arm 422c being most impactful. Incorporation of macrobubbles 425a at the bottom of the upflow arm 422a also achieves some oxygen transfer while contributing positively to total flow rate and turbulence.

Exemplary aeration systems 416 also include structure, especially within the horizontal arm 422b, to induce turbulence. More particularly, this structure could take the form of one or more directional plates 418 in the pipe or hose network. As best seen in FIG. 13, a first directional plate 418a may be located in the corner where the upflow arm 422a and horizontal arm 422b meet, and a second directional plate 418b in the corner where the horizontal arm 422b and downflow arm 422c meet. The directional plates 418 effectively create short angled channels in the corners of the pipe and hose network. The shape and configuration of the aeration system 410, especially the directional plate 418, are design variables that influence system performance. The directional plates 418 are adjustable, and there are a range of angles within which they can function effectively. These are from about a 10-degree to about a 45-degree slope of the directional plates.

Induced turbulence is an advantageous feature of disclosed embodiments, and the angles of the directional plates 418 determine the degree of induced turbulence, especially within the horizontal arm 422b and in the system's water flow generally. The tradeoff between turbulence and water flow volume determines which features to prioritize during operation. Additional structure and components can be employed to further induce turbulence. For instance, the fine bubble longitudinal diffusers 420a add another optional ability to expand water flow volume, turbulence, and oxygenation. Any bubbles 425, fine or coarse, micro or macro, that occur in the horizontal arm 422b increase turbulense. Because all of these factors occur at or near the surface of a waterway, near the top of the upflow and/or downflow arms or within the horizontal arm, especially in an airtight system, water pressure restrictions are minimal, resulting in high system efficiency.

An airtight lid 427 may be provided to allow access to the pipes or hoses 422 while providing an airtight seal when closed. The airtight lid 427 may be hinged or use any other mechanism to open and close. The lid 427 can be located at any point along the horizontal arm 422b at the top of the system 401. While some embodiments can employ a vented pipe that is not airtight for certain applications, an airtight system further improves efficiency. The airtight system requires buoyancy management to maintain optimal waterflow at the system/water body surface intersection but allows for more oxygen transfer within the upflow and horizontal arms. It also prevents escape of H2S or VOCs, allowing for their discretionary combustion or biological digestion as they are removed from the system at the horizontal/vertical pipe interface. Advantageously, exemplary remediation methods can capture off gas 31 from the system and cycle it through a microbial base floating island for clean-up. The airtight lid 427 can be sealed over the floating island 5 to capture the off gas 31 and cycle it through for a second pass or multiple passes.

An air vent 422f on the horizontal arm 422b allows spent air to escape for recycling or sparging or VOC biodigestion, as discussed in more detail herein. One or more ballast tanks 429 may be provided to adjust the height of the airlift assembly 410. Ballast tanks 429 can be attached at any suitable location, and in exemplary embodiments are provided adjacent the upflow arm 422a where it meets the horizontal arm 422b and another tank adjacent the downflow arm 422c where it meets the horizontal arm.

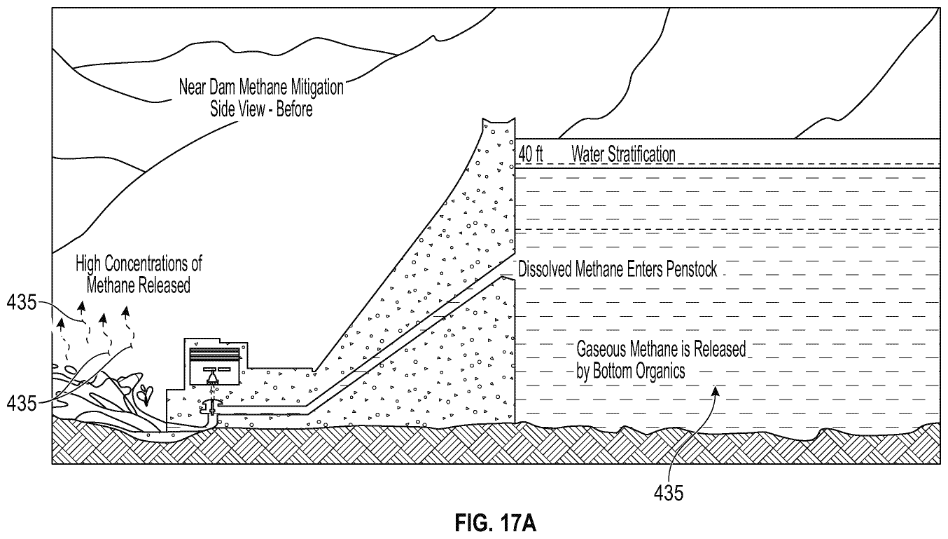

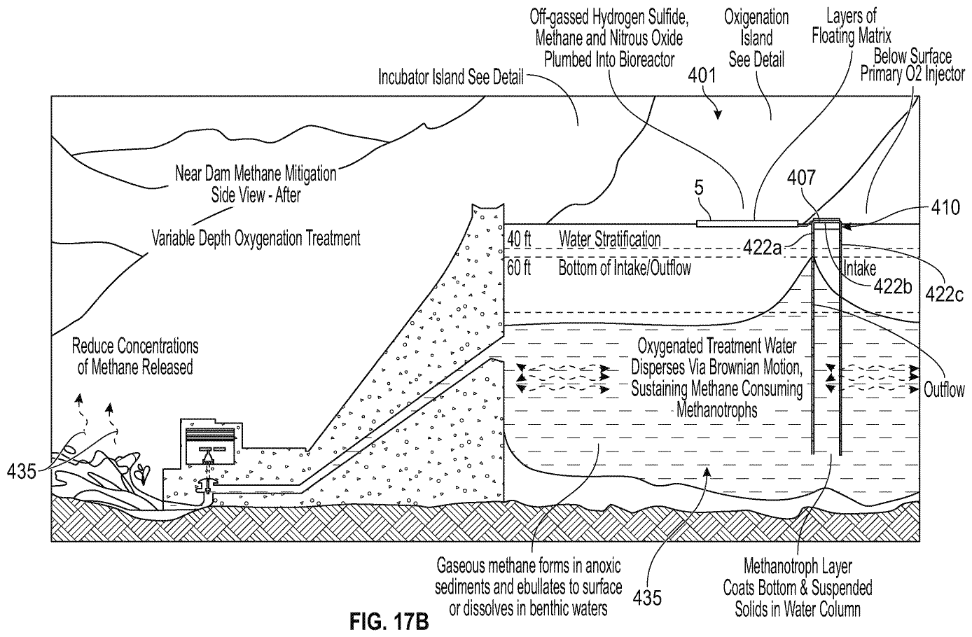

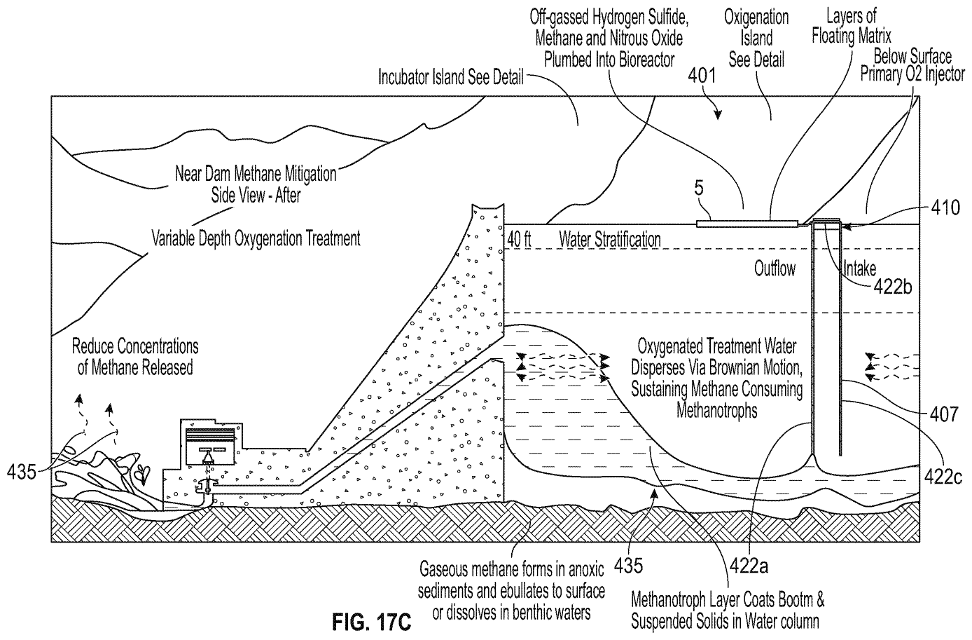

In operation, as generally illustrated in FIGS. 17A-17C, emissions of methane 435 and volatile organic compounds are reduced by deploying an airlift assembly 410 (having the layout and components described above) incorporated into a floating island 5 in a body of water 407. As water flows through the airlift assembly 410, the microbubble air diffusers 420, including the diffuser at the bottom of the upflow arm 422a and the longitudinal diffusers 420a in the downflow arm 422c, may introduce microbubbles 425b into the pipes or hoses 422 to add oxygen to the water. Additionally, or instead of microbubbles, macrobubbles 425a are introduced into the flowing water, which may defeat the buoyancy of the microbubbles 425b. This increases the residence time of the microbubbles 425b in the flowing water so they stay in the water longer. Thus, exemplary methods can manipulate microbubble residence time in both the inflow and outflow arms.

This integration of fine bubble oxygenation on both the upflow 422a and downflow 422c arms of the system 401 along with the other critical flow and buoyancy adjustability features provide key advantages. For instance, the large volume of benthic water raised by the system, including the massive water flow generated by coarse bubble air blower 424, can overcome micro bubbles 425b generated and carry them down to depth. More particularly, these factors defeat the buoyancy of the fine bubbles 425b by pushing them deeper into the water column and increase their residence time in the water flow by at least double.

The flow of water is so great and fast that it carries microbubbles 425b generated at or near the top of the airlift system 410 to the bottom benthic zone, where more complete transfer of oxygen into the bottom zone occurs. Thus, the system 401 can be managed for efficient oxygen transfer, since far more microbubbles 425b can be generated at the top and in shallow settings than in the high pressure bottom zone, where conventional aerators/diffusers are designed to operate. Another way of describing this phenomenon is that macrobubbles 425a, which pull large volumes of water into the airlift system 410 and up to the surface, creating high volume water flow, can defeat the positive buoyancy of microbubbles 425b over the entire length of the system 410 and convert some sizes to nanobubbles. In addition, the adjustable directional plate 418, the angle of which can be adjusted to regulate turbulence and water flow volume, and buoyancy features allow us to maximize for both flow rate and oxygenation rate.

By employing fine bubble diffusers 420 below the coarse bubble inflow point in the airlift system 410, water movement through the airlift system can be expanded while also managing residence time of the microbubbles 425b in the water flow. Similarly, due in part to lower volume and buoyancy of microbubble emission, the macrobubble driven water volume defeats buoyancy of microbubbles 425b in the system 410, including when fine bubbles are emitted directly into the outflow arm 422c. The high volume macrobubble driven water flow defeats the buoyancy of microbubbles, which become progressively less buoyant based on size reduction. It should be noted that in some embodiments, it may be preferable to introduct macrobubbles 425a without microbubbles 425 to better induce vibration.

When benthic waters are supersaturated with nitrogen, bubbles can get bigger. Use of a pure oxygen mixture with H2 or helium can produce nanobubbles from microbubbles, given sufficient residence time in the water column. Injecting microbubbles in upper water and pushing them down can also create nanobubbles by having increased pressures. The upper layer of water is CO2 depleted due to biological adsorption, supersaturated for O2 by photosynthesis, and O2 depleted in benthic zones by high BOD, COD, H2 and/or Helium.

This phenomenon allows for more complete oxygen transfer from conventional or concentrated oxygen fine bubbles 425b. The oxygen transfer is further enhanced by the low oxygen and relative cool ambient status of benthic water. Potentially this process may also favorably influence pure oxygen or other compounds as the oxygen transfer gas medium. Essentially this system synergizes the optimal features of both coarse 425a and fine 425b bubbles, particularly between the location of macrobubble introduction in the horizontal arm 422b and microbubble introduction in the vertical arms 422a, 422c. This synergy means that system efficiency can be significantly and cost effectively improved by using concentrated oxygen sources. The system causes significant turbulence of water and breaks up algae clumps, which advantageously clarifies surface waters.

Thus, the aeration system 410 achieves nearly 100% oxygen transfer efficiency from microbubbles 425b to water in the down flow portion, i.e., up to 100 percent transfer of oxygen to the water flowing through the pipes or hoses 422. Conventional diffusers that experience oxygen transfer only while bubbles are rising vertically are considered performing optimally if they achieve 30% oxygen transfer. The disclosed systems more than double that number, while retaining the systems' unique targeted benthic oxygenation feature.

The positioning of the inflow and outflow points of the system 401 depend on the purpose, i.e., oxygenation of harvesting of sludge/sediment. When the objective is to oxygenate the benthic zone, intake and outflow points must be kept at least slightly above the sludge/sediment layer. TSS concentrates at this point, frequently in colloidal form and flows from shallower areas by density-driven gradients. This jelly-like solid is coated in biofilm and when kept even slightly aerobic (0.2 ppm or greater), forms an aerobic barrier of methane consuming methanogenic activity. Positioning intake and outflow points within 12″ or less of concentrated benthic sludge achieves this, as long as the temperature of treated water is not increased by more than 1.5 degrees Celsius. When the objective is to harvest sludge/sediment, as discussed in detail herein, the intake point must be in the sludge/sediment while the outflow point is discretionary and can be directed outside of the water body.

Wastewater systems where the present systems and methods are deployed can be a source of a meaningful volume of energy due to the high volume of flow rate through the remediation system, on the one hand, and allowance of bubbles in the downward outflow arm of to not be defeated by the flow, but instead make their way to an outflow valve at the juncture of the horizontal 422b and vertical downflow arm 422c, although there is some prospect of the gas accumulation point occurring in the downflow arm 422c itself.

Advantageously, microbubbles (or nanobubbles) 425b can be introduced anywhere within the airlift system 410. Adding microbubbles 425b and managing them by positioning where they enter the water flow maintains them in a space or pushes them deeper. When introduced into the downflow arm 422c by fine bubble longitudinal diffusers 420a or carried into the downflow arm, the residence time of the microbubbles 425b can be managed to achieve complete transfer of oxygen within the microbubbles to the water flowing through the system 401.

However, if the water is oxygenated, complete transfer does not occur. This is due, at least in part, to the higher water flow induced by the coarse air blower 424 introducing macrobubbles 425a, which can overcome the buoyancy of the microbubbles 425b. Thus, the system can maximize oxygen transfer by synergizing between macrobubbles 425a with the airlift and microbubbles 425 in the vertical pipes. Microbubbles 425b also can be employed in the upflow arm 422a, increasing their level to further facilitate VOC removal (including H₂S) and reduce or terminate VOC emissions from the water flow, as discussed in more detail herein.

VOCs are frequently associated with nutrient-impaired water. Anoxic, high sulfate-containing water can emit hydrogen sulfide when exposed to the system's oxygenation. Sulfates, though ubiquitous, occur in higher concentrations in ancient seabed zones around the planet. Advantageously, several features of exemplary gas remediation systems enable mediation of H₂S and other VOCs that emit in the off-gas from disclosed systems. H₂S is remediated by bacteria in aerobic waters. For example, introducing additional oxygen (or other gases) during periods of exposure to H₂S emissions can abbreviate or terminate emissions. Microbubbles 425b transfer oxygen more efficiently than macrobubbles 425a, as relatively more surface area of the individual bubbles is exposed to water.

It should be noted that introducing commercial sources of pure or concentrated oxygen into the system airflow may be practical in certain settings to increase the amount of oxygen transferred to water when chemical or biological oxygen demand is high due to H₂S emissions or biological conditions associated with eutrophic or nutrient concentration status.

VOCs can be captured in the air or gas downflow arm 422c, typically at the intersection of the horizontal arm 422b and the downflow arm 422c, and optionally combusted or biologically digested. Advantageously, methods incorporating floating islands 5 enable cycling this gas stream into and through the biofilm digestive surface area of the floating island, which is an elegant solution for cycling even extremely high concentration examples of VOCs by bioremediation into healthy, aerobic food webs. CO2 emissions can be adsorbed by water and pH can be controlled by addition of limestone, etc.

Adding hydrogen or other oxidizing/reducing chemicals such as KMnO4, ozone, or peroxides may be strategic when targeting organic compound removal, due to specific chemical reactions that could be designed for. The aggressive mixing associated with the system, combined with the ability to pull from specific stratification zones is likely to enhance efficacy of chemical treatments.

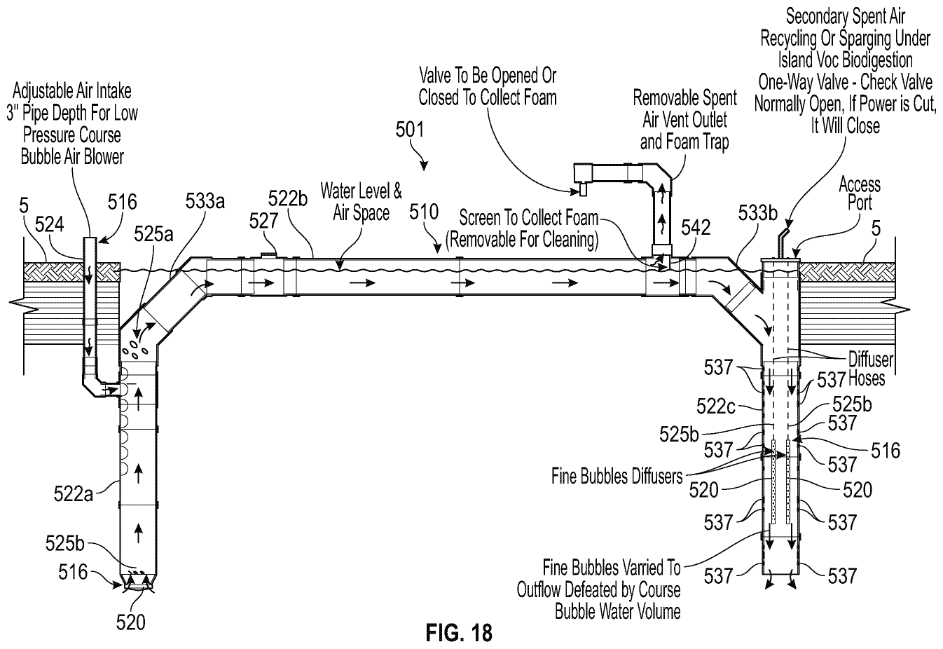

Turning to FIGS. 18-22, exemplary systems 501 designed for sediment harvesting will now be described. System 501 has a similar overall structure to previously described embodiments with some variations and additional features that provide the ability to separate light and heavy sediments and concentrate heavy metals and/or rare earth elements. Airlift assembly 510 includes a network of pipes or hoses 522 and several components that serve as an aeration system 516. A sediment harvesting system 501 may be incorporated with a floating island 5 having a biofilm-reactive matrix 12 inoculated with active methanotroph culture.

An exemplary configuration of pipes or hoses 522 has an upflow arm 522a, a horizontal arm 522b at the top of the network, and a downflow arm 522c. The three arms 522a, 522b, 522c of the pipe or hose network are fluidly connected and may be separate components held together mechanically or one piece integrally formed. Where the upflow arm 522a meets the horizontal arm 522 and where the horizontal arm meets the downflow arm 522c, angled channels 533a and 533b are formed by angled pipe or hose pieces. An airtight lid 527 may be located at any point along the horizontal arm 522b at the top of the system 501 to allow access to the pipes or hoses 522 while providing an airtight seal when closed. In addition, one or more air vents allow escape of spent air and recycling or sparging. Valves can be used for recycling, sparging, to aid in VOC biodigestion, flow reversal for plugging, and/or priming the upflow arm 522a.

The aeration system 516 includes one more more coarse air blowers 524 and air diffusers 520. In exemplary embodiments, a coarse air blower 524 is in fluid communication with the network of pipes or hoses 522 and introduces macrobubbles 525a into the system 501. Fine bubble or microbubble diffusers 520 can be located at various points in the network of pipes or hoses 422 and emit microbubbles 525b. In exemplary embodiments, one or more longitudinal diffusers 520 are located in the downflow arm 522c. As discussed in detail above, the high volume macrobubble driven water flow defeats the buoyancy of microbubbles 525b, which can be regulated, and this provides up to 100% oxygen transfer from conventional or concentrated oxygen within fine bubbles 525b communicated into the outflow stream.

In exemplary embodiments, the airlift assembly 510 incorporates graduated hole sizes for better sediment evacuation. More particularly, the sidewalls of the downflow arm 522c define a plurality of holes 537, with screening size smallest at or near the bottom and relatively larger screening size holes going up at or near the middle of the downflow arm 522c. The graduated size holes 537 allow for evacuation of light sediment. The same phenomenon can be achieved in a pipe or tube configuration. Corrugated pipe, on the interior side, may facilitate this process. In exemplary embodiments, the graduated hole sizes are from about 1/16 of an inch starting about an inch above the lowest point in the flume to about ⅛ and progressively larger, up to about ½ inch. Advantageously, the varying hole sizes allow for light, fine sediment to vibrate out of the airlift assembly 510.

This vibration, which is created by the coarse bubbles in the airlift assembly 510, is advantageously synergized into a rocker table or shaker table effect. The amount of vibration varies depending on different factors, including the height of the air intake point of the system 501. The higher the air intake point is located in the upflow arm 522a, the more vibration occurs across the horizontal arm 522b of the system 501. While the optimal air intake point is from 27 to 36″s below water surface for our coarse air blower, the 27″ depth results in the greatest vibration. The relative weight of the system 501 also influences vibration. The lighter the system 501 is, the more it vibrates. When the system is composed of a relatively light polymer instead of metal, vibration increases, contributing to the rocker table effect and resulting in enhanced separation of light and heavy components of sediment. Directing air downward and high volumes of air cause the pulsing effect.

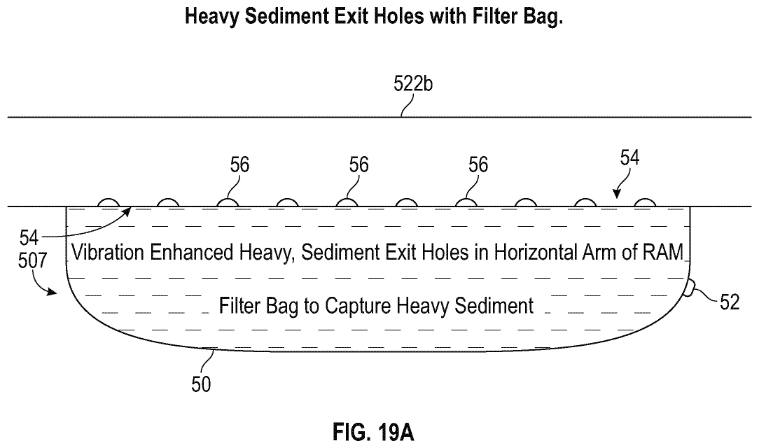

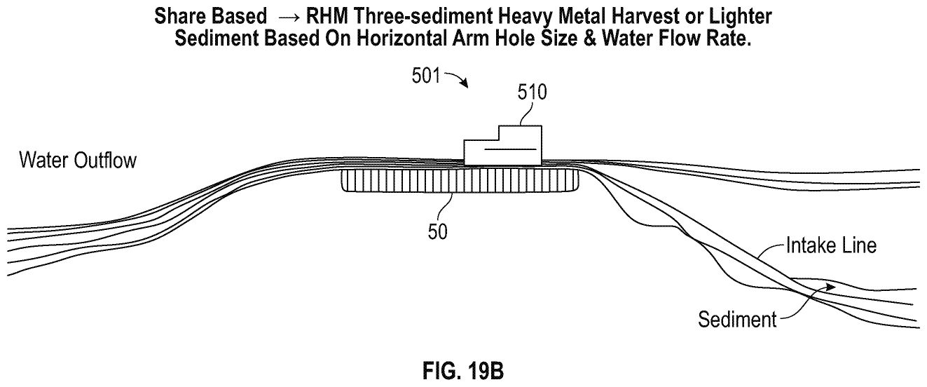

Certain features of the horizontal arm 522b contribute to sediment collection. In exemplary embodiments, an angled filter screen 542 is located in the horizontal arm 522b. The angled filter screen 542 can direct suspended solids into an evacuation channel for sludge harvest/removal. This snow fence effect results in lift of light sediment and settling of heavy sediment. The light sediment emits out of and away from the flume, while the heavies settle onto the bottom. As best seen in FIGS. 19A and 19B, in exemplary embodiments, one or more collection bags 50 may be provided underneath the horizontal arm 522b of the system, and the heavy sediment falls into the bags. Some lighter sediments may be valuable, and also can be harvested using collection bags 50 associated with targeted hole filter screen/mesh size.

A depth sensor 52 attached to the collection bags below the flume bottom can be employed to notify the operator regarding optimal harvest timing. In addition, when the system 501 is incorporated into a floating island 5, the supporting floating island's reserve buoyancy can be synergized with a sensor alarm. For sludge harvest and removal, expanded sidewall hole size allows for escape of any suspended sludge into an exit line that carries the sludge out of the treated water body. Advantageously, the expanded sidewall hole size results in added concentration of sludge and silt in the exit line. Both the upflow arm 522a and the horizontal arm 522b may incorporate a range of access or exit hole sizes.

Other features of the horizontal arm 522b include a filter mesh 54 as the arm's bottom surface. That is, the entire bottom of the horizontal arm 522b can be a filter mesh 54. As sediment-containing heavy metals move horizontally long the horizontal arm 522b, heavies gravitate toward the bottom of the flume. This progressive feature allows for accumulation of heavies in and through the filter mesh 54. The incidence of sediment collection orifices or apertures 56 contribute to this phenomenon, allowing for a progressive expansion of capture of heavy fine particulates in the filter mesh. The same phenomenon occurs in reverse with respect to light particulates, which also progressively diminish in concentration as they travel along the horizontal arm 522b. The adjustable flow rate of intake water/sediment influences the settling process, and the length of the horizontal arm 522b impacts heavy metal collection efficacy.

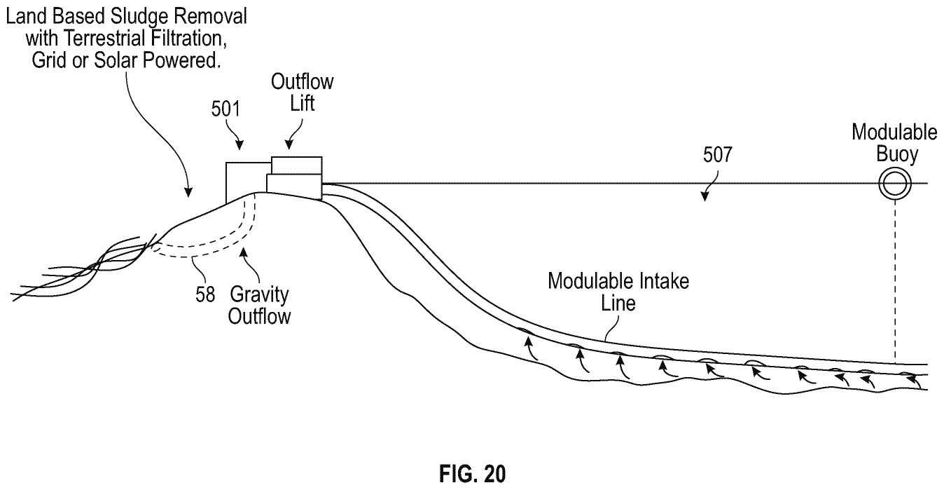

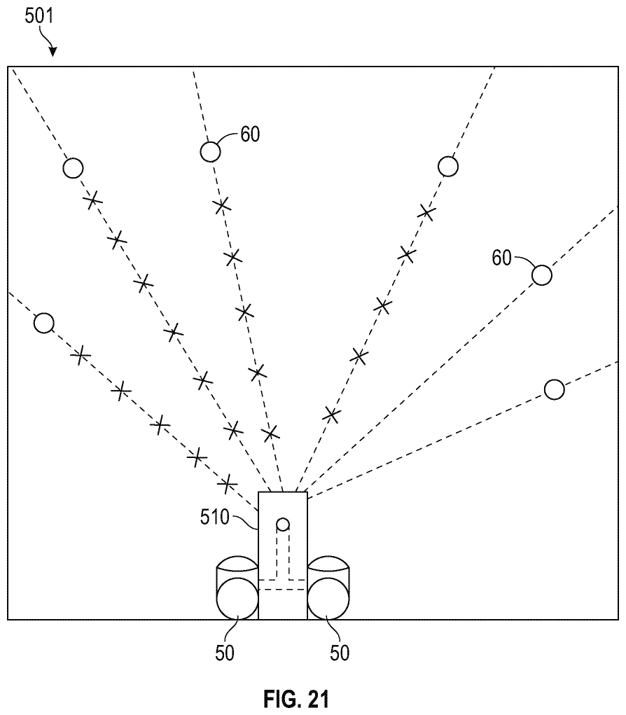

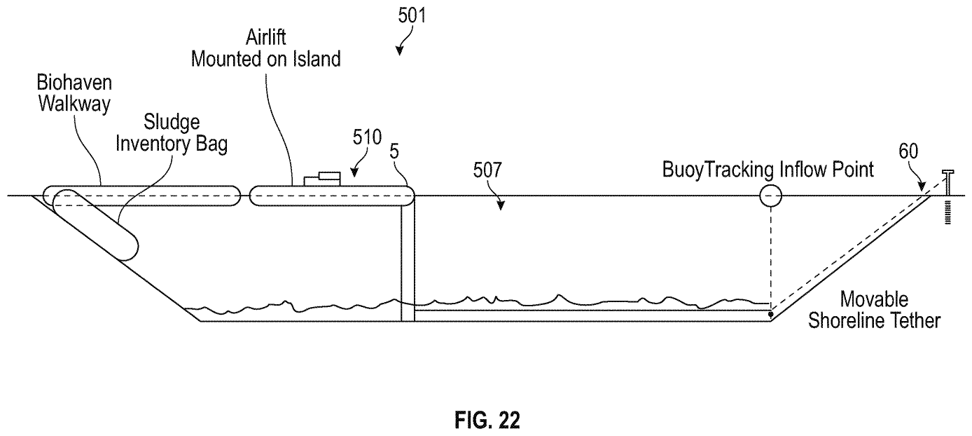

Referring to FIG. 20, in exemplary embodiments, sludge harvest/removal is optimally associated with a gravity flow exit channel 58. That is, rather than having to pump exit line content up from the water body 507, the system configuration allows for gravity flow to carry outflow sludge/silt away from the system, thus maintaining minimal pressure gradients and maximizing for flow rate efficiency. The ability to lift exists with air/water plugs. As shown in FIGS. 21 and 22, embodiments of the system 501 could have an island tether configuration 60 to provide adjustable target sediment/sludge harvest across a water body. In exemplary embodiments, the system could be powered by solar panels 44, and the system could operate intermittently based on variable power input.

When the system is used for sediment dredging, toxic and noxious gas emissions in dredged water/sediment outflow can be reduced by air exhaust collection and treatment using FTW systems. Gas bubbles entrained and released sediments disturbance can also be done by bioremediation by locating a FTW above the sediment dredging location.

Thus, it is seen that improved gas remediation and sediment harvesting systems and associated methods are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

It also should be noted that many additional variations on the theme of water propulsion and oxygenation are possible. Said variations are also considered and anticipated in this disclosure. Some of the accompanying drawings and graphics depict oxygenation and propulsion techniques, including but not limited to, an airlift charging substation and variations on bubble injection/baffles/tilt of runway/directional plate tilt/depth of runway/perforations of runway piping, angle of repose of runway, depth of intake and outtake of runway, and more.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A gas remediation and sediment harvesting system, comprising:
at least one airlift assembly including an aeration system and one or more pipes or hoses configured for directional water flow, the one or more pipes or hoses including an upflow arm, a horizontal arm, and a downflow arm;
the aeration system including a coarse air blower in fluid communication with the one or more pipes or hoses;
wherein the coarse air blower introduces macrobubbles into the one or more pipes or hoses such that the macrobubbles create pressure to move the water flowing through the one or more pipes or hoses such that the airlift assembly vibrates, thereby concentrating heavy metals and rare earth elements.

2. The gas remediation and sediment harvesting system of claim 1 wherein a first angled channel is formed where the upflow arm meets the horizontal arm, and a second angled channel is formed where the horizontal arm meets the downflow arm.

3. The gas remediation and sediment harvesting system of claim 2 wherein the first and second angled channels are formed by one or more directional plates.

4. The gas remediation and sediment harvesting system of claim 2 wherein the first and second angled channels are formed by angled pipe or hose pieces.

5. The gas remediation and sediment harvesting system of claim 1 defining at least one sediment collection orifice in one or more of the one or more pipes or hoses.

6. The gas remediation and sediment harvesting system of claim 1 wherein the macrobubbles generate water flow by displacing water and create turbulence in the horizontal arm.

7. The gas remediation and sediment harvesting system of claim 1 wherein the at least one airlift assembly comprises a second airlift assembly or a pump to pressurize outflow air in the horizontal arm.

8. The gas remediation and sediment harvesting system of claim 1 wherein the horizontal arm includes an airtight lid and one or more air vents.

9. The gas remediation and sediment harvesting system of claim 1 wherein the downflow arm has a bottom section and a middle section and defines a plurality of holes that are relatively smaller at or near the bottom section and are relatively larger at or near the middle section.

10. The gas remediation and sediment harvesting system system of claim 1 wherein aeration to the one or more pipes or hoses enables remediation of volatile organic compounds.

11. The gas remediation and sediment harvesting system of claim 1 wherein the airlift assembly is incorporated into a floating island on a surface of water.

12. The gas remediation and sediment harvesting system of claim 1 wherein the horizontal arm includes a riffle box or has a filter mesh as its bottom surface.

13. The gas remediation and sediment harvesting system of claim 1 further comprising one or more solar panels providing electricity to power the system.

14. The gas remediation and sediment harvesting system of claim 1 further comprising one or more collection bags to collect heavy sediment.

15. A method of gas remediation and sediment harvesting, comprising:
deploying an airlift assembly incorporated into a floating island in a body of water, the airlift assembly including an aeration system and one or more pipes or hoses including an upflow arm, a horizontal arm, and a downflow arm such that water flows through the one or more pipes or hoses; and
introducing macrobubbles into the upflow arm or the horizontal arm such that the macrobubbles create pressure to move the water flowing through the one or more pipes or hoses causing vibration within the one or more pipes or hoses, thereby providing a rocker table effect.

16. The method of claim 15 further comprising introducing microbubbles into the downflow arm to increase oxygenation to outflow water.

17. The method of claim 15 further comprising closing an airtight lid on the horizontal arm to capture off gas.

18. The method of claim 15 further comprising discarding light sediment and concentrating and harvesting dense sediment concentrates.

19. The method of claim 15 further comprising containing outflow air from the horizontal arm and directing the outflow air under and through adjacent floating treatment wetlands.

20. The method of claim 15 further comprising directing outflow air and associated biogas under and through biofilm reactive surface area of floating treatment wetlands.
